(19) United States
(12) Patent Application Publication
(10) Pub. No.: US 2003/0040946 A1
(43) Pub. Date: Feb. 27, 2003

(54) Travel planning system and method

(76) Inventors: Stanley C. Sprenger, West Vancouver (CA); Robert W. Morrow, North Vancouver (CA)

Correspondence Address: CLARK, WILSON, 800 - 885 WEST GEORGIA STREET, VANCOUVER, BC, V6C 3H1, CA

(21) Appl. No.: 09/887,029

(22) Filed: Jun. 25, 2001

(51) Int. Cl. G06F 17/60

(52) U.S. Cl. 705/6

(57) ABSTRACT

A vacation planner system wherein a user is able, at a web site, to completely develop and confirm a travel plan including the cohesive integration of the travel components of transportation, lodging and activities. The system provides the user at each stage of the planning, a range of options that has been determined based on information previously supplied by the user, simplifying the travel planning process.

### NOTICE REGARDING COPYRIGHT MATERIAL

A portion of the disclosure of this patent document contains material which is subject to copyright protection. The copyright owner has no objection to the facsimile reproduction by anyone of the patent document or the patent disclosure as it appears in the public Patent Office file or records but otherwise reserves all copyright rights whatsoever.

### TECHNICAL FIELD

This invention relates to methods of planning and purchasing packages of goods or services over a network and more particularly to determining and confirming a travel plan or related services using such a network.

### BACKGROUND

The Internet has proven to be a useful tool for those determining travel plans, for example vacations and business trips. To plan a complete trip, many different components are required. For example transportation, such as air travel, and car rentals may be necessary for the traveler to arrive, get around and depart from the destination. The traveler will need lodging at a hotel, bed & breakfast or the like while at the destination. The traveler will also likely be participating in various activities while at the destination. Such activities could include sports such as golf, skiing and tennis, and other activities such as dining, hiking, and the theatre. Some activities have elements of other components, for example a cruise includes both travel and lodging.

At present, travel planning is usually done by travel agents creating “packages” appropriate to what the agent thinks the client wants. The client often has little idea of the options available if he wants changes in the travel plan and does not know the details of the services in the plan.

The Internet has become a source of information for those looking for information about their travel options. There are many web sites devoted to selling services related to travel, however, such web sites offering such services in a travel context are limited to transportation and/or lodging, and do not provide travel plans also including activities to entertain the traveler. Some web sites do sell “travel packages” but they are sold as self-contained units (i.e. lodging, travel, and some activities, with no options for the user). Other web sites provide a form on which the user can present information about their preferred activities, lodging and travel preferences but such sites require the user to fax or email such information to an agent, and then wait for the agent to contact them.

Some related patents that relate to the above described interaction between a user and a travel based web site include U.S. Pat. No. 5,948,040 for a travel reservation information and planning system and U.S. Pat. No. 5,237,499 for a computer travel planning system.

### SUMMARY OF THE INVENTION

There is provided a method for a user to develop a travel plan having at least two travel components, comprising the steps of: (a) providing a plurality of parameters on which each said travel component is parameterized by at least one of said plurality of parameters, wherein each said parameter is associated with an initial range of values; (b) providing first means for choosing by user, a value for a first parameter; (c) determining the respective ranges of values of all parameters other than said first parameter, responsively to said chosen first parameter value according to predefined relationships between said other parameters and said first parameter; and (d) presenting to the user said determined range of values for said other parameters.

### BRIEF DESCRIPTION OF FIGURES

Further objects, features and advantages of the present invention will become more readily apparent to those skilled in the art from the following description of the invention when taken in conjunction with the accompanying drawings, in which:

FIG. 1 is an embodiment of a destination banner according to the invention;

FIG. 2 is an embodiment of a destination date banner according to the invention;

FIG. 3 is an embodiment of a destination detail banner according to the invention;

FIG. 4 is an embodiment of a vacation planner preferences page according to the invention;

FIG. 5 is an embodiment of a lodging preferences page according to the invention;

FIG. 6 is an embodiment of a lodging selection page according to the invention;

FIG. 7 is an embodiment of an air travel preferences page according to the invention;

FIG. 8 is an embodiment of an air travel selection page according to the invention;

FIG. 9 is an embodiment of an airport shuttle/limo preferences page according to the invention;

FIG. 10 is an embodiment of an airport shuttle/limo selection page according to the invention;

FIG. 11 is an embodiment of a car rental preferences page according to the invention;

FIG. 12 is an embodiment of a car rental selection page according to the invention;

FIG. 13 is an embodiment of a snow school preferences page according to the invention;

FIG. 14 is an embodiment of a snow school selection page according to the invention;

FIG. 15 is an embodiment of a ski/board rental preferences page according to the invention;

FIG. 16 is an embodiment of a ski/board rental selection page according to the invention;

FIG. 17 is an embodiment of a lift ticket preferences page according to the invention;

FIG. 18 is an embodiment of a lift ticket selection page according to the invention;

FIG. 19 is an embodiment of a golf course information page according to the invention;

FIG. 20 is an embodiment of a golf course preferences page according to the invention;

FIG. 21 is an embodiment of a golf course (tee time) selection page according to the invention;

FIG. 22 is an embodiment of an activities information page according to the invention;

FIG. 23 is an embodiment of an activities preferences page according to the invention;

FIG. 24 is an embodiment of an activities selection page according to the invention;

FIGS. 25 and 26 are embodiments of a my plan page according to the invention;

FIG. 27 is an embodiment of a contact information page according to the invention;

FIG. 28 is an embodiment of a my party page according to the invention;

FIG. 29 is an embodiment of a party details page according to the invention;

FIG. 30 is an embodiment of a party details plan for a second party member according to the invention;

FIGS. 31 and 32 are an embodiment of a confirm plan page according to the invention;

FIG. 33 is an embodiment of a billing information page according to the invention;

FIG. 34 is an embodiment of a thank you page according to the invention;

FIG. 35 is an embodiment of a save plan page according to the invention;

FIG. 36 is an embodiment of a send to friend window according to the invention;

FIG. 37 is an embodiment of a log in window according to the invention;

FIG. 38 is an embodiment of a password reminder window according to the invention;

FIG. 39 is an embodiment of a my plans page according to the invention;

FIG. 40 is an embodiment of a virtual tour window according to the invention;

FIG. 41 is an embodiment of an agent's plan retrieval window according to the invention;

FIG. 42 is an embodiment of a summary bar according to the invention;

FIG. 43 is an embodiment of a currency converter window according to the invention;

FIG. 44 is an embodiment of a policies window according to the invention;

FIG. 45 is an embodiment of a privacy policy window according to the invention;

FIG. 46 is an embodiment of a calendar window according to the invention;

FIG. 47 is an embodiment of an edit party member window according to the invention;

FIG. 48 is an embodiment of a web chat window according to the invention;

FIG. 49 is an embodiment of a call back window according to the invention;

FIG. 50 is a flow chart showing the web pages visited by a user of the travel planning system;

FIG. 51 is a block diagram of a system according to the invention;

FIG. 52 is an embodiment of the vacation preferences web pages;

FIG. 53 is a screen shot of an alternative embodiment of a vacation preferences web page;

FIG. 54 is a flow chart showing how the user accesses the vacation planer system; and

FIG. 55 is an embodiment of a virtual tour window according to the invention.

### DETAILED DESCRIPTION OF PREFERRED EMBODIMENTS

### 1. Definitions

In the present specification and claims, the following terms will have the following meanings:

“aggregator” is a party that sells a package of component goods and/or services that at least partially inter-relate;

“category” of goods or services means a fundamental and distinct class to which such goods or services belong. Categories of services include lodging, transportation, activities, skiing, and restaurants. Categories of goods include DVDs, CDs, books, hard drives, and monitors.

“choose” means to make a choice of a value of a parameter from a menu of choices, entered by a user, or otherwise, including acceptance of defaults;

“component” means a subset of a larger whole. For example, a “travel plan” might have several components of transportation, lodgings and activities. For another example, a “computer system” has several components, such as input/output devices, CPU and memory. Components are typically parameterized.

“confirm” means to order, reserve, book or pay for goods or services, as distinct from developing a plan related to obtaining goods or services;

“destination” means the resort, region or city at which the user intends to spend at least a portion of the trip being planned;

“identity” means the distinguishing characteristics associated with a user relative to a plan or similar object, such as a password, an email address or a user ID;

“multimedia” means using, involving, or encompassing at least one media (audio, video, text, graphics and the like);

“parameter” means a variable or factor that is used, often with other parameters, to express or formulate a component. A value for a parameter is chosen by the user based on the individual situation (through direct user input of a value, a user choice of a value from a range of values presented or by an intelligent default). Some parameters are for subjective preferences of the user (e.g. large beds, near golf course) while others are objective attributes of the user or a person that the user is selecting on behalf of (e.g. number and ages of the travellers, date of arrival and departure at a destination). Although the primary purpose of parameters is to incorporate the user's situation, not all of the parameters are under complete control of the user. For example, there are predefined relationships between some of the parameters which, when a value is chosen, limit or determine the range of possible values of other parameters that the user can choose. For example, if the user chose a value of the date parameter that corresponds to the summer, it may be that the range of values for activities will be limited or determined so that skiing is no longer a choice for the user;

“package” means an collection of goods or services that interactively form a whole, but each can be provided by different goods or services providers, e.g. a computer (with components like memory, monitor, etc., provided by different manufacturers) or a vacation (with components like activities, lodging, transportation, etc., provided by different service providers);

“personal information” means information about an identifiable individual, including address, name, credit card number, phone number, and the like;

“select” means to make a selection of a good or service selected from a menu of choices, entered by a user or otherwise, including acceptance of defaults;

“total price” means the cumulative price or cost of selected goods or services, and may be inclusive or exclusive of taxes;

“travel plan” means a plan for a trip including at least one of the following travel components: lodging, transportation and activities; wherein where there are two or more components such travel components are “interactive” with each other, i.e. information used to plan or confirm a travel component (or a part thereof) is used to plan or confirm another travel component;

“user” means an entity capable of using the vacation planner system and includes software agents and software robots;

“user profile” means a collection of parameters about a user and/or the travelling party that interact with other parameters when creating a travel plan;

“vacation” means a trip, including pleasure trips, travel for business or educational purposes, attending a conventions and participating in a tour;

“vacation sales consultant” means a person who provides information or other travel related services to users, and includes travel agents;

“via” means by means of;

“web page” is a document on the World Wide Web (or Internet). Every web page is identified by a unique Uniform Resource Locator (URL). A web page is a file readable by web browsers and may contain prompts to the user including common user interface controls such as data entry fields, list boxes, drop-down boxes, check boxes, push buttons, radio buttons and the like. In a preferred embodiment, HTML and XML scripts are used to display the pages and accept data from users via the web browser. Using hypertext, a link is a selectable connection from one word, picture, or information object to another. In a multimedia environment such as the World Wide Web, such objects can include sound and motion video sequences. The most common form of link is the highlighted word or picture that can be selected by the user (with a mouse or in some other fashion), resulting in the immediate delivery and view of another file. The highlighted object is the anchor. The anchor reference and the object referred to, constitute a hypertext link;

“web site” means a unique location on the World Wide Web containing a home web page, and also includes non-computer analogues, like URLs printed into the pixels of paper advertisements;

“window” means any of the area into which a computer display may be divided and on which distinctly different types of information are displayed.

### 2. Introduction

In a vacation planner system according to the invention, a user is able, at a web site, to completely develop and confirm a travel plan including the cohesive integration of the travel components of transportation, lodging and activities. The system provides the user at each stage of the planning, a range of options that has been determined based on information previously supplied by the user. This simplifies the (often overwhelming) travel planning process.

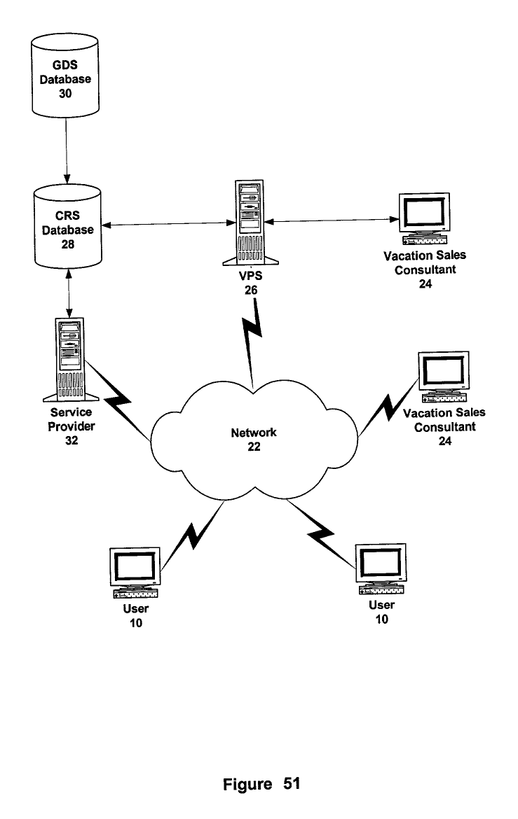

In a preferred embodiment of the invention, and as seen in FIG. 51, a user 10, using a computer, terminal or other communication device such as a wireless device, accesses the vacation planner system (VPS) 26 via a network 22. Vacation sales consultants 24, such as travel agents, are also able to access VPS 26 via network 22 and may be able to access VPS 26 directly. Vacation sales consultants 24 may use the VPS 26 to develop travel plans for resale or assist users, while many users 10 will access the VPS 26 for their own purposes, for developing travel plans for planning vacations, personal trips or business trips. Network 22 will normally be open (i.e. the Internet), but may be closed for limited access (e.g. to vacation sales consultants or travel organizers for businesses). Network 22 may include wireless devices, or be an extranet or intranet. VPS 26 may be accessible via kiosks, PDAs, wireless devices or the like.

VPS 26 allows user 10 to choose services to provide travel components of a travel plan. Such travel components are parameterized in VPS 26, i.e. values of parameters are used by VPS 26 to determine choices of services available or appropriate for user 10. Parameters may be preferences (e.g. choice of location of lodging) or they may be factual (e.g. age, number of members of party). The value of some parameters may be other parameters. In general to choose a service via VPS 26, user 10 is asked to choose values for parameters on a preferences web page. Following this choice, VPS 26 will provide a selection of services to user 10 that meet the chosen values of the relevant parameters.

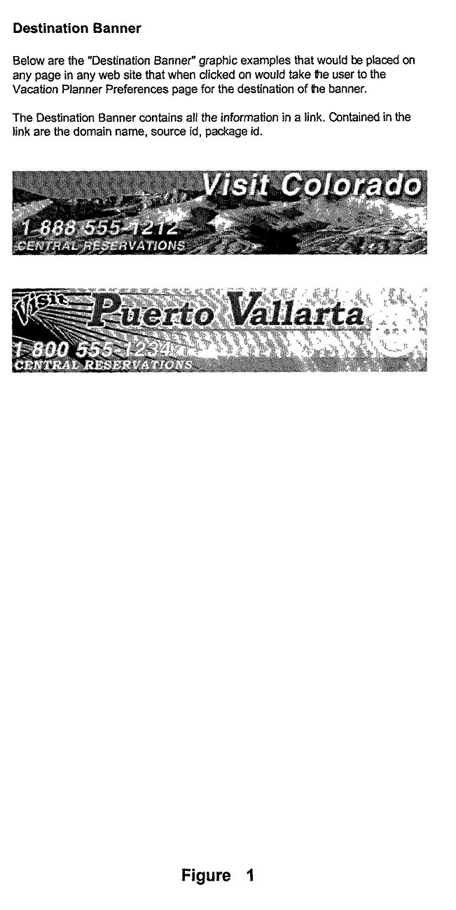

VPS 26 is stored on web servers of a conventional type and accesses database(s), including the Central Reservation System 28 (as known in the art), containing information used by the VPS 26 and used to save travel plans generated by users 10. User 10 will often access VPS 26 by way of banners as seen in FIGS. 1, 2 and 3 that may be placed at web sites throughout the Internet via conventional means. User 10 may also access VPS 26 via a virtual tour window (as described below), directly linking to VPS 26 or other conventional means. Clicking on a banner links the user to VPS 26 and begins the travel planning process.

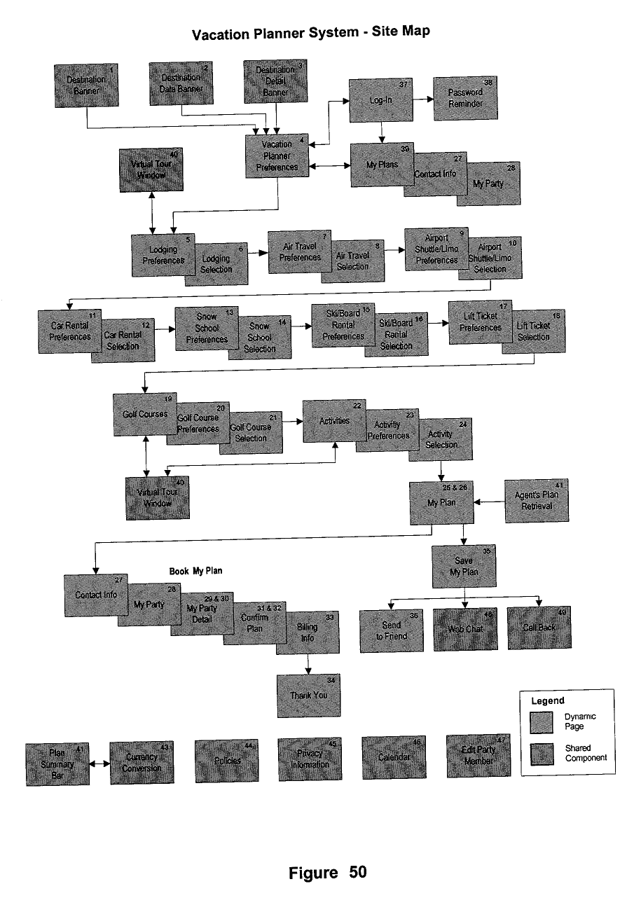

User 10 will preferably access and use VPS 26 via web sites. As user 10 develops the travel plan, VPS 26 uses the information already provided by user, throughout the remainder of the travel planning process. A flow chart showing the web site pages through which a user 10 may go through while planning the trip using an embodiment of VPS 26, is at FIG. 50.

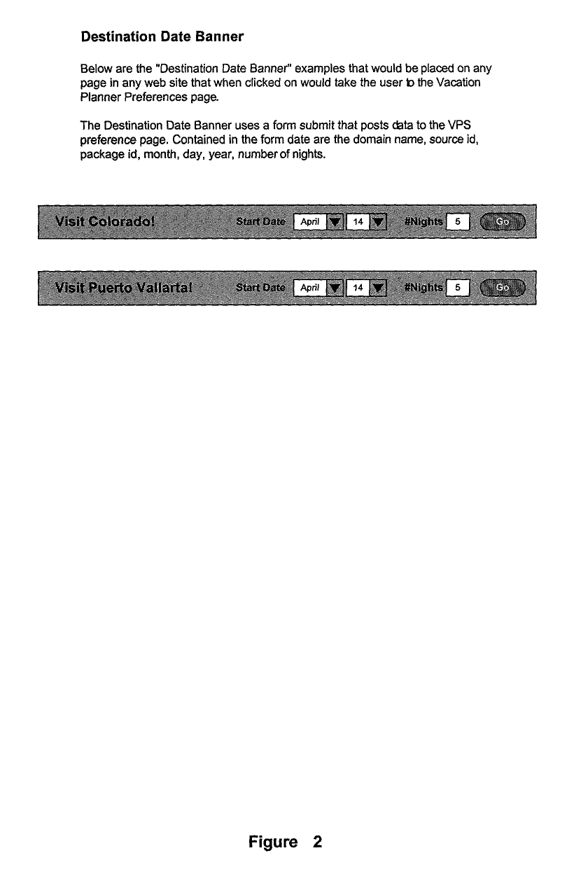

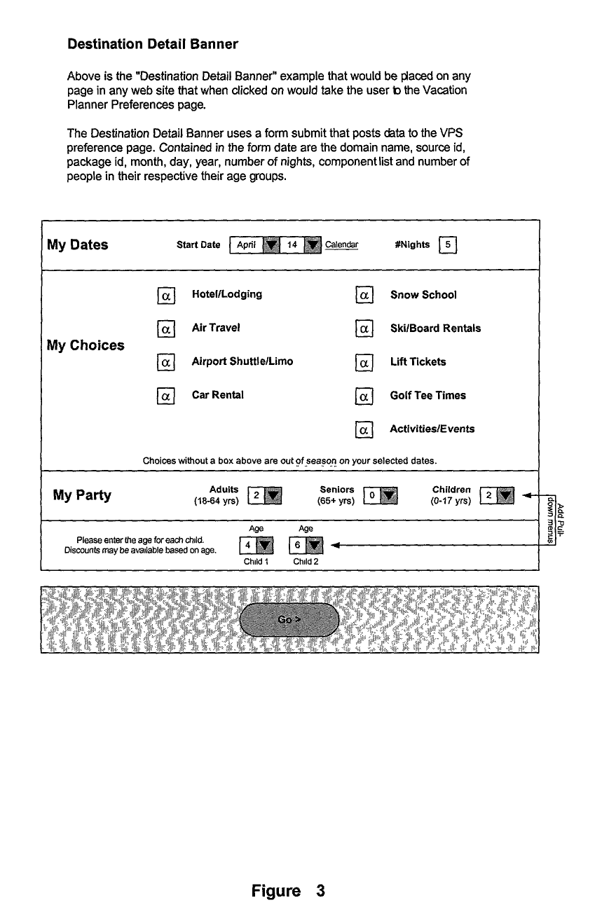

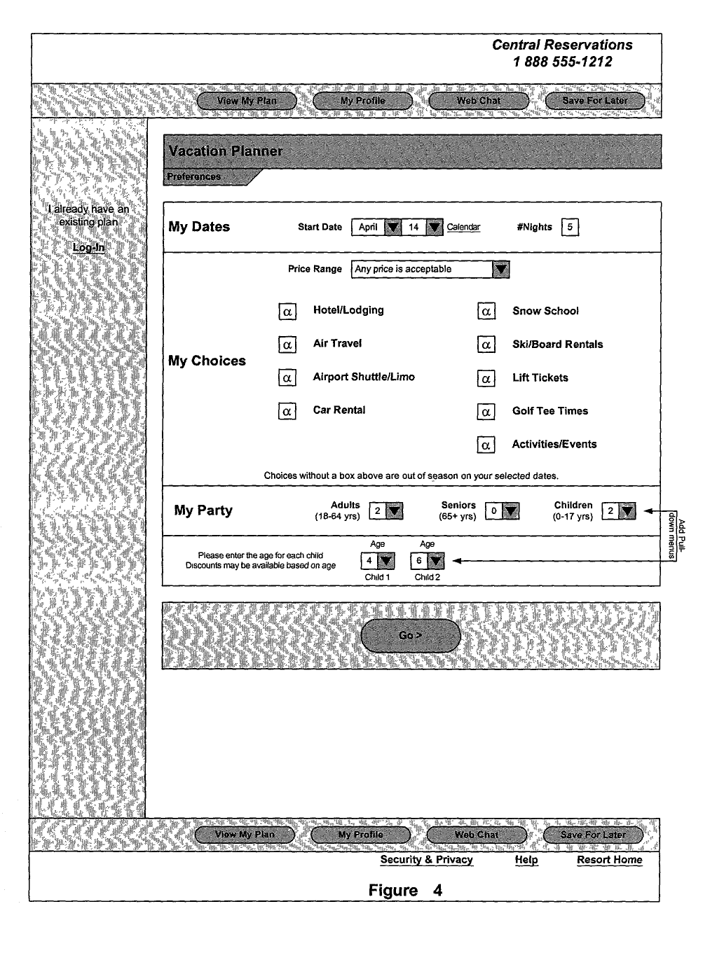

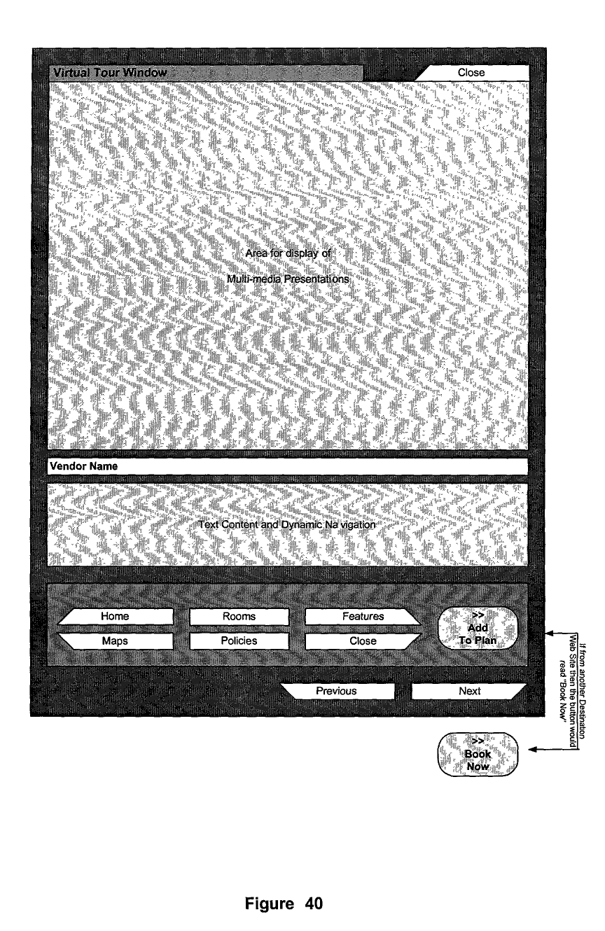

The user will typically be drawn to VPS 26 through (as described below) a destination banner (FIG. 1), a destination date banner (FIG. 2) or a destination detail banner (FIG. 3). These banners lead user 10 to the vacation planner preferences web page (see FIG. 4). From there, user 10 can login (step 37) and access plans already or partially developed. Alternatively user 10, can begin to develop a plan by clicking on the “Go” button and then being led to the appropriate preference page based on user 10's choices at the vacation preferences page. In general, user 10 will be guided through web pages first outlining the user's preferences about lodging and the like and then selecting from services that satisfy those preferences. The user may, at certain preference pages (or selection pages), view a virtual tour window (see FIG. 40) of the services available. After developing the travel plan, user 10 may confirm the plan or save it for future consideration. The flow chart seen in FIG. 50, is an example of how a user 10 may use or be guided through VPS 26 by a default sequence of web pages (for example, logically responsive to values chosen at the vacation planner preferences page). The VPS 26 default sequence can always be overridden by user 10 at any time during the planning process, who may develop (or continue to develop) the plan as user 10 wishes (e.g. according to personal idiosyncracies or personal methods of approaching for planning a trip). For example, after selecting lodging services (step 6), user 10 could then move to the snow school preferences page (step 13) using the summary bar (as described below) or simply move on as guided by VPS 26 to the Ski/Board Rental preferences web page (step 15) or even return to the vacation planner preferences page.

### 3. The Banners

There are three types of banners typically used to bring a user 10 to the vacation planner preference website to access VPS 26: a destination banner (as seen in FIG. 1), a destination date banner (FIG. 2), and destination detail banner (as seen in FIG. 3). Such banners are designed for use at web sites separate from the web site of VPS 26, such as sites carrying advertising from the operator of VPS 26, or affiliates or partners of the operator, or providers of trip-related services, such as golf courses, hotels, airlines, etc. Alternatively users 10 can link to the VPS 26 web site directly through conventional methods such as entering a URL or through a virtual tour window (as described below). The point is that entering VPS 26 website is done typically through remote points on the World Wide Web so that upon arrival at VPS 26, user 10 is shown a planning facility that is already “preconfigured” for his wishes and, as will be explained below, will, on an ongoing basis during the planning of the trip, remain “configured” to his chosen preferences on a real-time basis, drawing real time inventory and other information from third party providers, and presenting to user 10 the options limited to his wishes. The analogy to the banners of the present invention, is a salesperson stationed or travelling remotely from headquarters (perhaps with a “sandwich board”) to attract custom and upon meeting a good prospect, obtains some preliminary information to radio back to headquarters, so that by the time the prospect arrives at headquarters, the stationary sales person there is ready with a sales promotion configured intelligently for that client based on such preliminary information.

All types of banners contain at least a link to the VPS 26 web site. Some banners pass additional values and information entered by user 10 to VPS 26 allowing customization of the following web pages and determination of the range of values of all other parameters responsive to the values chosen. The information and values that may be passed to VPS 26 in the different types of banners include:

Type of Banner Information

| Type of Banner | Information |
|---|---|
| Destination | domain name, source id, package id |
| Banner: | |
| Destination | domain name, source id, package id, date, |
| Date Banner: | number of nights |
| Destination | domain name, source id, package id, date, number of |
| Detail Banner: | nights, services list and number of |
| | people (and their age groups), price range and destination |

The domain name is the domain name to which user 10 will be linked. This information is used by VPS 26 to determine the value for the parameter for trip destination, customize the look and content of the VPS 26 web site (as described below), for statistical purposes (to track where users are coming from), and for reward purposes (to reward affiliates or partners that provide users 10 for VPS 26).

The source id identifies which banner (in VPS 26's list of all banners in use) and which web site (or other source) brought user 10 to VPS 26 and is saved in association with the user's travel plan so VPS 26 can report sales generated by each source id.

The package id represents information about the particular trip selected (e.g. destination) and may be used by VPS 26 to determine the range of values to display to user 10 on web pages in VPS 26 based on predefined relationships. The package id may also be used by VPS 26 to trigger special business rules (e.g. limit the range of hotels for selection) and prices. Commonly such packages will limit selections to certain combinations of service providers.

The arrival date and number of nights choices set the start date and number of nights (and therefore the departure date) for the travel plan. These values are passed to queries for other parameters for the trip and are used to set (often intelligent) defaults for some parameters (e.g. the number of nights to be spent in the hotel, the dates for air travel, the first day of activities and the like). Optionally, instead of the number of nights, a departure date may be requested.

The services list determines the services that will appear in the summary bar (as described below) and that are seen by user 10 in the vacation planner preferences web page. The services appearing in the summary bar will also depend on the values of such parameters as the destination and the dates when the user will be at the destination.

The number of people in the travelling group and their age groups (i.e. child, senior, adult) are used to determine the range of values of other parameters and particularly are used to determine the prices of certain services.

The price (or a range of prices) is a value of a parameter used by VPS 26 to determine ranges of possible values for other parameters determined by the chosen price for the trip.

All of the information provided by destination banner to VPS 26 is provided in the link. The destination date banner and the destination detail banner use forms, that when submitted to VPS 26, provide additional information.

In a preferred embodiment, the look and content of the VPS 26 web site will be customized for each destination (and optionally, the timing of the trip). VPS 26 contains several destination web sites. Each destination is associated with a different URL linked to by a banner and users 10, when clicking on a banner, pass the URL request to VPS 26. Each destination may have its own root directory containing configuration data such as the destination's id (as known by VPS 26), as well as custom multimedia and style sheets for such destination. The root directory also contains a link to the shared code in VPS 26 that is used to drive all of the destination web sites.

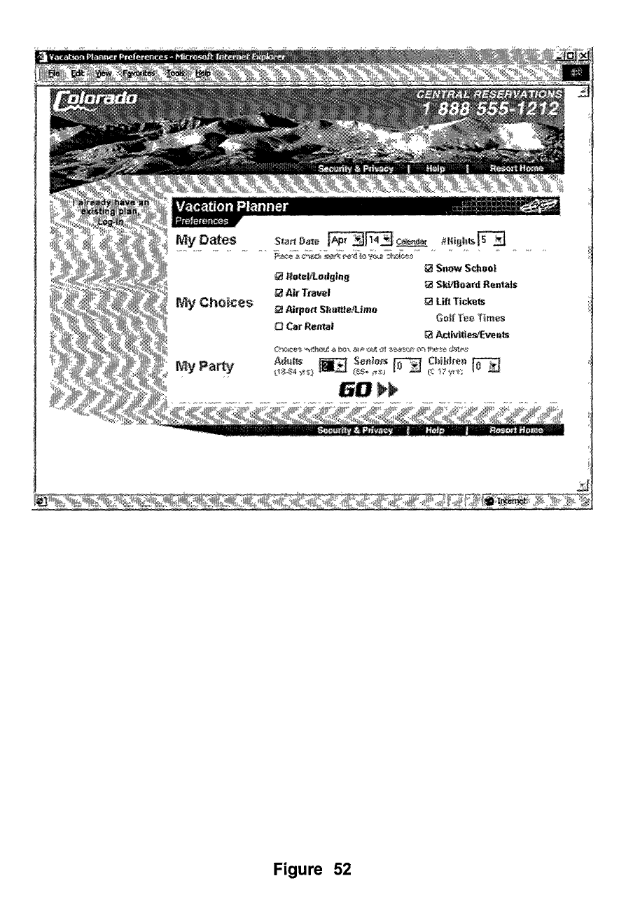

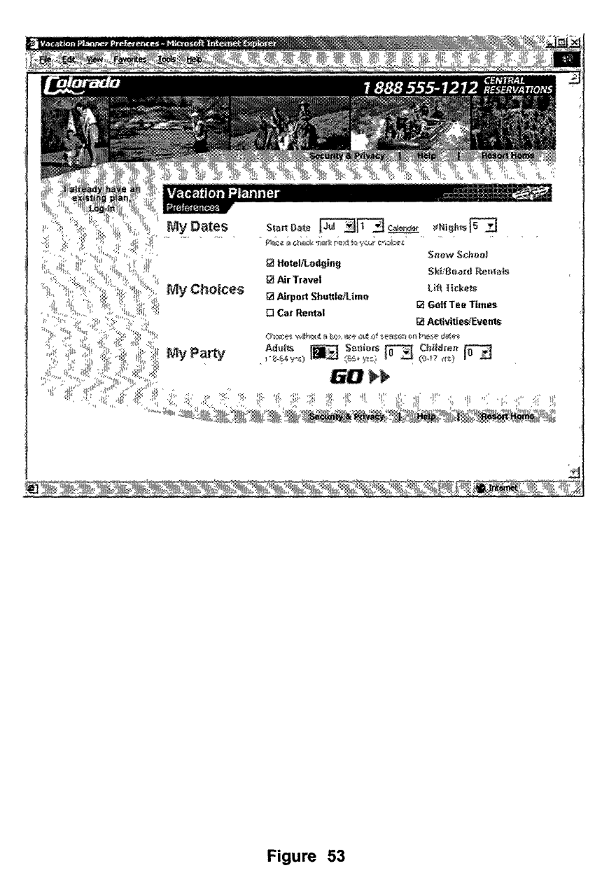

When the shared code sends instructions to display a custom graphic, the code reads a link to the custom multimedia area under the destination root directory and the client browser loads the appropriate multimedia. FIGS. 52 and 53 display a vacation planner preferences page with appropriate multimedia for the vacation planner preferences pages for a user planning a trip to Colorado in the winter and in the summer, respectively.

The shared code also uses the destination provided by user 10 (as determined by the domain name or by other means such as a chosen value by user 10) to retrieve a list of parameters from VPS 26 appropriate to the destination. VPS 26 displays the services offered by the VPS 26 at the destination as well as the season start and end date associated with each service (for example the ski season start and end date determine the range of values for the skiing activity). The arrangement of the services on following web pages will be determined by the destination and other information, such as the date. For example if user 10 chooses a date that is out of season for a service, the range (or set) of values available for choosing will be empty. Such service then will be disabled (or not appear), on the main preferences page and will not appear on the summary bar as being activatable. For example in FIG. 52, the golf option may not be chosen given the date of April 14 provided by user 10.

Some destinations may have different multimedia and styles displayed depending on the season in which user 10 plans to be at such destination (for example green and wooded in summer for a ski resort, and mountainous and snowy in the winter). To accomplish this, the destination has more than one folder (or directory) under its main web site for such destination. Each folder contains the appropriate multimedia and style sheets for the season and a link to the shared code. The following web pages accessed by user 10 will use the appropriate season folder based on the dates chosen. If user 10 changes the date of the trip while using VPS 26, then the multimedia and services available will change appropriately. While planning a trip that bridges the change of one season to another, VPS 26 present appropriate graphics (e.g. change from snowy graphics to spring graphics) as user 10 develops his plan, day by day, and crosses the winter/spring cross-over date. VPS 26's sensitivity to dates requested by user 10 applies to graphics and other parameters and options, whether viewing a web site for a museum for future collections of artists (which is more in the nature of advertising for the museum) or a web site for the commerce of goods and services.

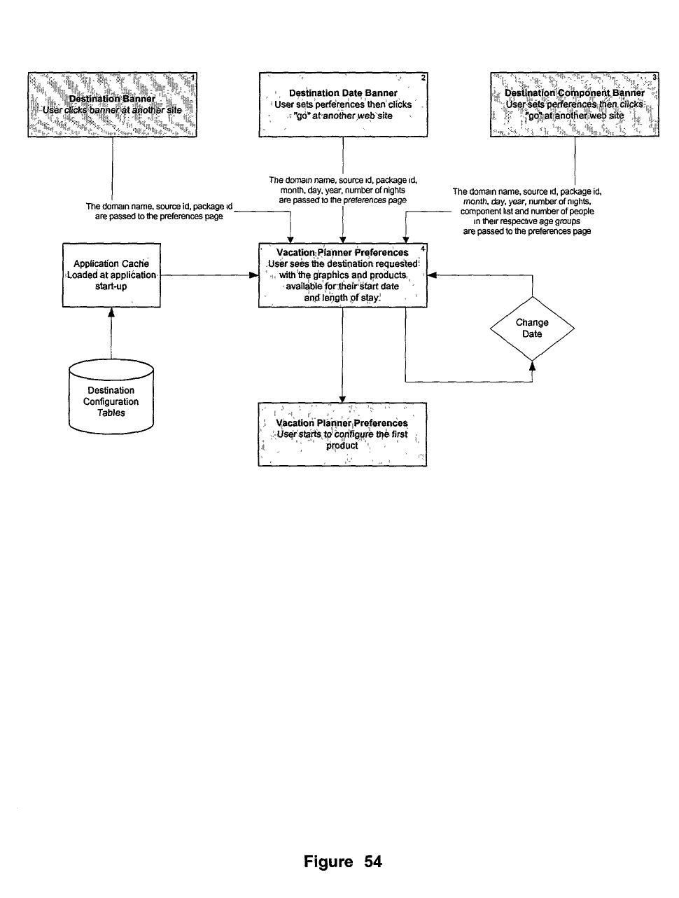

Frequently, user 10 will reach a vacation planer preferences web page (as seen in FIG. 4) with some information already provided by the user through the banners, so VPS 26 will fill in the vacation planer preferences web page accordingly, where such information is known by VPS 26. If user 10 enters the vacation preferences web page directly using a destination banner, upon entering the date, VPS 26 may amend the vacation preferences page accordingly to disable (or not display as activatable) as choosable services, and present appropriate multimedia. A flow chart graphically displaying the process by which user 10 may reach the vacation planner preferences page is seen in FIG. 54.

Alternatively, if the user has chosen a price or price range (i.e. a budget) before reaching the vacation preferences page (or while providing information to such page), the services shown may be determined as services available based on price. Services that are returned by VPS 26 throughout the development of the travel plan that, when selected, exceed the budget, cause VPS 26 to prompt the user to reconsider (for example, to choose another price range or select another service).

In an alternative embodiment of VPS 26, user 10 could be spending “points” (for example from an incentive program) or another cash equivalent, rather than money. In such a case user 10 could provide a value for the points that are available to be “spent” and VPS 26 would provide information about the points “spent” on services, and provide a running tally of the points remaining.

At any time in the development of the travel plan, the user has the option to change the chosen values of previous parameters, as will be further detailed below. Furthermore, while the embodiment described herein relates to travel, other time or date sensitive goods or services could be purchased or selected using a system according to the invention, such as a web site used for renting equipment or apartments, or for time sharing.

### 4. Shared Information

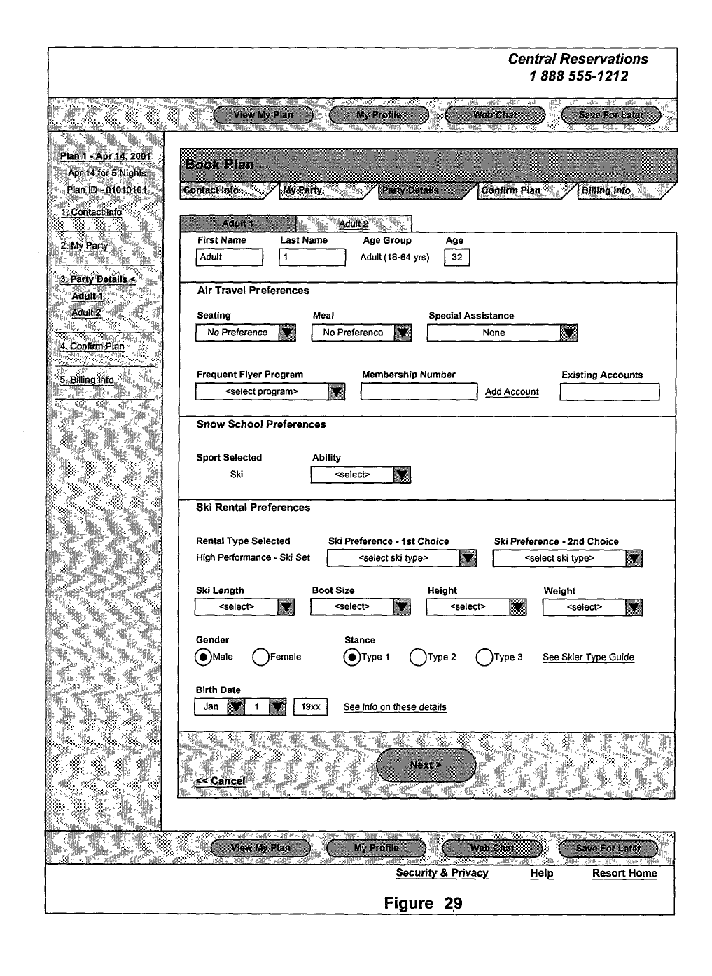

A feature of VPS 26 is how it uses information provided by the user throughout the development of the travel plan. When at a preferences web page, if user 10 has chosen values that determine that the range of other parameters is limited (for example by choosing to visit a winter resort during the summer), certain values (i.e. selections and choices) will no longer be available to user 10 (e.g. skiing), and VPS 26 will disable, not display, or otherwise indicate the unavailability of such selections or choices. Choosing dates and a destination are clearly two important values that will be passed on throughout the planning process and determine much of the information to be presented to user 10. However, other parameters also play important roles. Examples of such parameters are those that make up the “user profile” of user 10 (see FIG. 29).

Instead of immediately (or early in the planning process) asking for names, ages, and other personal information from user 10, VPS 26 requests only the information it needs, at the time it is needed, to begin to build information about each party member. For example, VPS 26 will typically early in the planning process (as seen in FIG. 4) request that user 10 provide the number of adults, seniors, and children (and possibly the ages of the children if relevant) who will participate in the trip. This is the minimum information required for the VPS 26 to prepare an accurate quote (considering how the price of many services vary with age of participant), and allows user 10 to develop a travel plan without being required to provide personal information.

VPS 26 identifies each party member by assigning default names and age groups (e.g. Adult 1, Adult 2, Senior 1, Child 1, etc.) to distinguish between the party members and to associate costs and other information with such individual party members. More detailed information may be added from certain web pages in the planning process, and will be required before the confirmation of the plan (for example, to pay). When the development process begins, default names are generated and held in a user profile in a session state by VPS 26. If user 10 at any time enters names (either real or assumed), more specific ages, or changes the number of people in the party, the user profile is updated appropriately and used in the following web pages accessed (and in web pages previously accessed).

An important parameter for the purposes of determining the costs and availability of services, is age. Many services have costs that are lower for children, and the particular age groups vary (for example lift tickets may have a discount for children under 10, while ski rentals have discounts for children under 12). Services such as daycare will not be available to children over a certain age. VPS 26 requests the ages of children as they are needed. For example, early in the planning process VPS 26 may only know that a child is present. Perhaps VPS 26 will ask user 10 if the child is under two years of age when determining the cost of airfare. Later in the planning process, VPS 26 may ask user 10 if the child is between one to five; six to twelve; or thirteen and up, to determine the cost of lift tickets. Based on the answers to previous queries regarding the child's age, VPS 26 may be able to determine the information needed without further inquiry (for example, if VPS 26 knows the child is from six to twelve years of age, that child is also older than two, for the purposes of other services where that age characteristic is important for pricing).

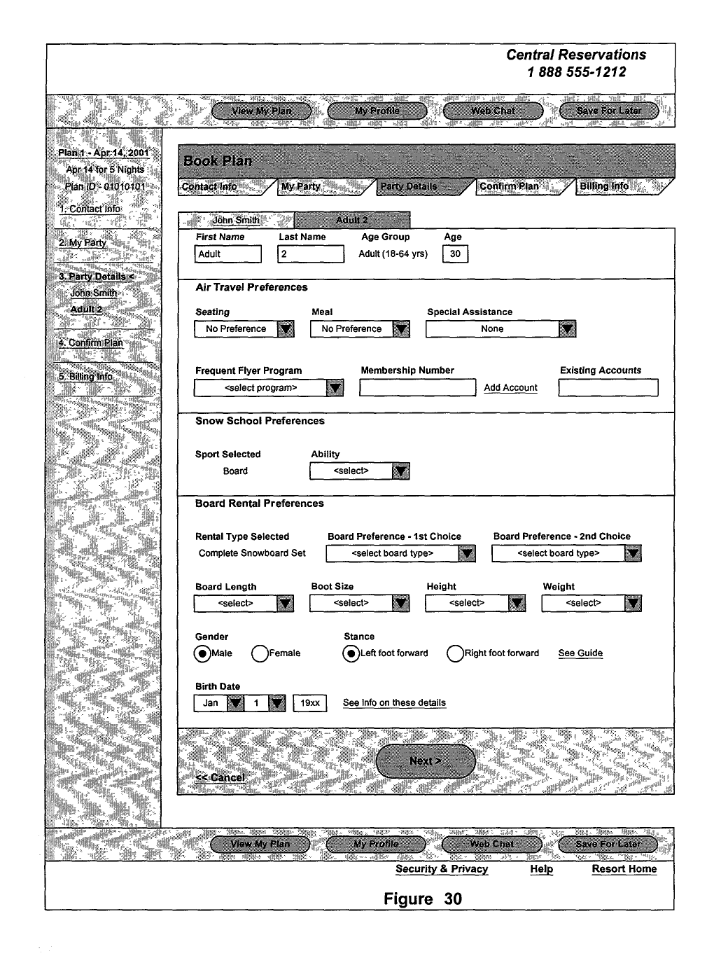

More detailed information is necessary for confirmation as user 10 will be making reservations and purchasing tickets, etc. and the service providers will require personal information, such as verifiable credit card information to allow such. In addition to information such as names and ages, there are also specific customer details that may be required to obtain some services (e.g., foot size and height for ski rentals). Before the travel plan is confirmed, user 10 may complete a form on a web page containing the specific details necessary for the services selected. Optionally, user 10 may provide this information to VPS 26 or the service provider at a later date, even as late as the day the party member is partaking of the services. For each party member, VPS 26 steps through the services selected and builds a list of the required details. Then a web page is displayed to user 10 with appropriate sections for each party member requesting the details needed for the services associated with such party member (see FIGS. 29 and 30).

Of note is that user 10 may remain anonymous until the detailed personal information is required, i.e. at the time user 10 confirms the plan. Until such time, no personal information is required, although it may be provided to (and removed from) the user profile at any time prior to confirmation of the plan.

The user profile may also have values for choosing that will allow user 10 to have certain display preferences. For example, user 10 may be very economically inclined and wish to be provided a display in the order of ascending price, the services for his selection. Alternatively, such an order may be the default order, and user 10 may be able to change it by changing his user profile so that the display in is descending order; or, if user 10 is “middle of the road”, the average price (of all the services available) is determined, and the options for services are shown in order of increasing variance from that average. Changing the user profile can be done at any time during the development of the plan and all such changes will be automatically made used to determine ranges of values for the other parameters.

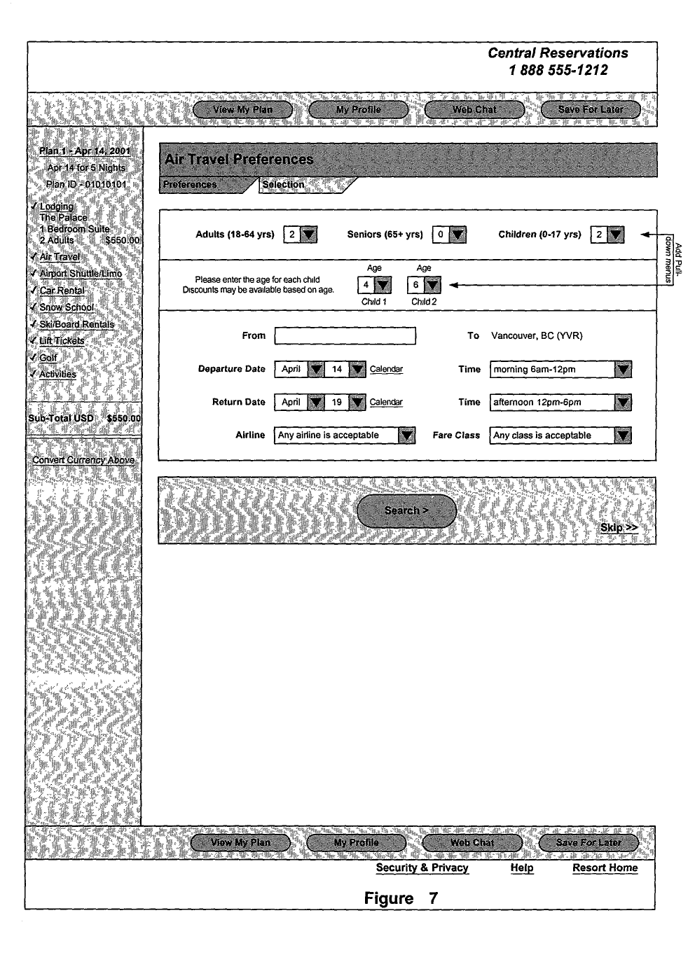

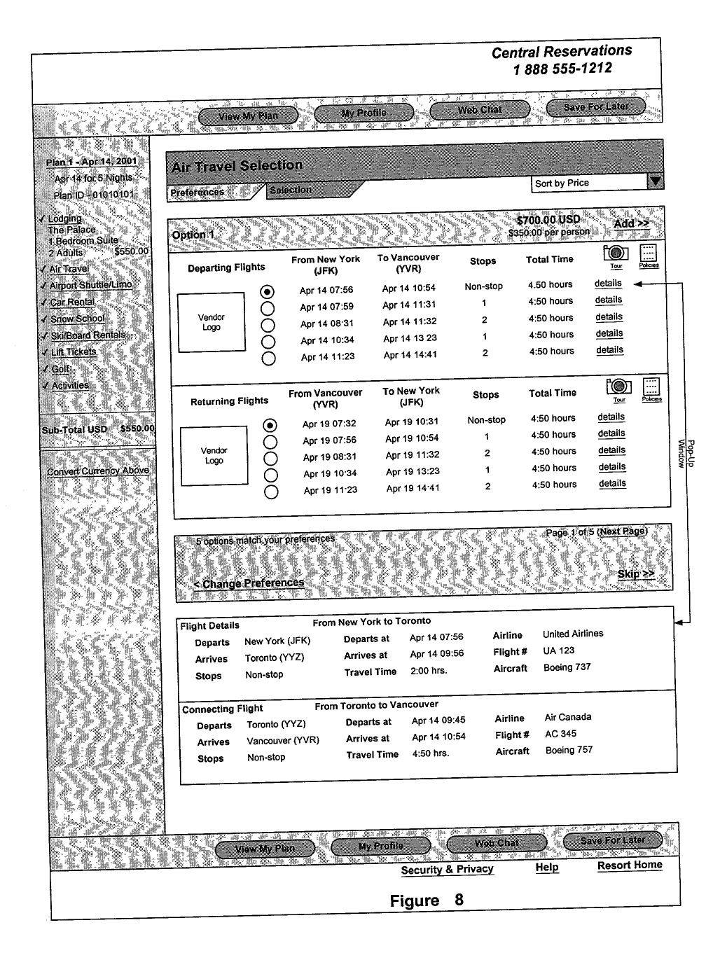

In another example, as seen in FIG. 7, to choose air travel to and from the destination, at the Air Travel Preferences Page, the user enters preferences for date (which defaults to the already chosen dates), destination (which also defaults), starting location, time range, airline, fare class, and airport and submits the page. Other information, such as the user profile will be used by VPS 26 to determine the number of seats, and the age of the passengers. Other flight preferences (e.g. seating preferences and even seat choice, special diet needs) may be provided by the user in the user profile, or optionally the flight preferences page. All relevant values and preferences are transformed into an XML request and sent to the Central Reservation System 28 (CRS), which then queries the Global Distribution System 30 (GDS) interface. The GDS 30 responds to the CRS 28 query and the CRS 28 then organizes the information and provides it to VPS 26. As seen in FIG. 8, the response from CRS 28 is displayed as a series of selections of arrival and departure flights grouped by price.(e.g. all $700 flight options are shown first, followed by more expensive flights further down the screen or on following web pages). Different service providers (i.e. airlines) may appear as different groups. User 10 may select any option from the grouped list of departing flights and the grouped list of returning flights and will pay the same amount regardless of the particular selections from that group. The list of options preferably only contains basic information like departure and arrival date and time and the number of stops for each flight. Preferably, a “details” button or link is provided that opens a separate window with detailed information about the flight and any connections. Alternatively such information may appear on the lower portion of the page. Furthermore, user 10 may click on the tour icon to view information and multimedia presentations about the airline, the airport and other relevant information.

VPS 26 can also take advantage of arrangements between an airline and other service providers. This information will be invisible to user 10, and may provide significant savings.

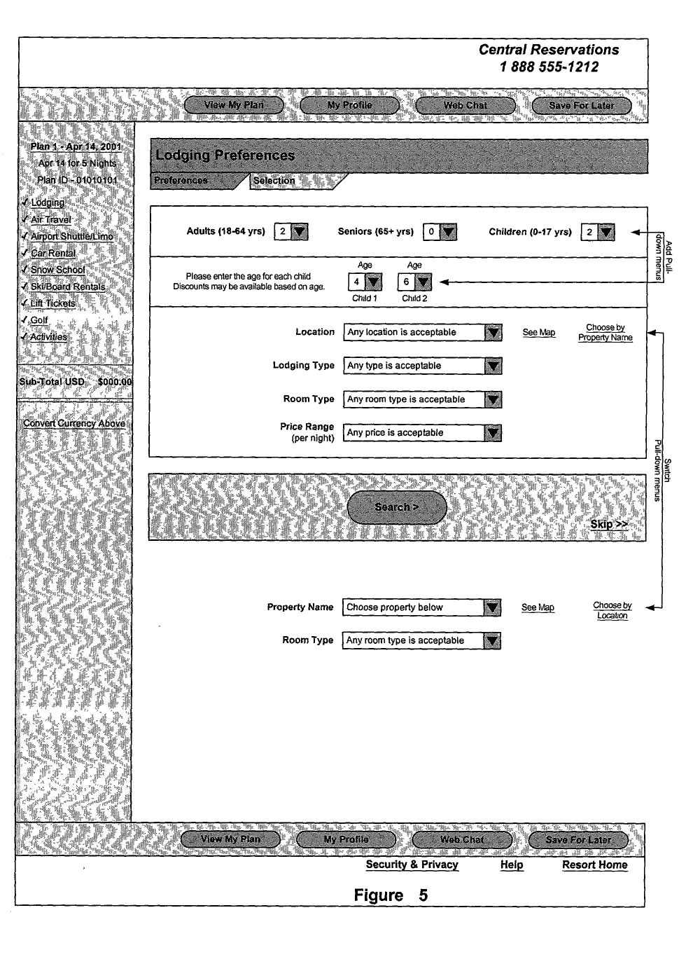

Another example of the use of parameter values that interact to determine the selections of services available to user 10 is that of lodging (as seen in FIG. 5). In an embodiment of the invention, the user is prompted with four pull-down menus to provide a number of preferences. Such preferences include: the preferred location of the lodging (e.g. near the ski resort, downtown, near the golf course, etc.); the lodging type (e.g. hotel, bed & breakfast, campground); the room type (one bedroom, two bedroom); and the price range (e.g. $50-100; $101-200; $201-300; or $301 and up, per night). The default settings for each option are preferably broad (e.g. for Location it is “Any location is acceptable”). As user 10 chooses a value for a preference, the values available for choosing in the other preferences are determined according to predefined relationships. As an example, if user 10 chooses lodging located near the ski resort, perhaps the lowest price range ($50-100) will be removed or grayed out in the price range menu as there is no lodging available in that price range for that location. Information already provided (such as the number of members of the party, or the budget for the trip), may also determine the range of values of the parameters and their availability. For example, the price ranges may vary depending on the season at their destination (e.g. a winter resort has higher prices in the winter season and lower prices in the summer season, and the price range values available for choice will reflect that i.e. they are determined by the date of the vacation). The length of the stay may also limit options (i.e. one hotel has no two bedroom lodgings for five consecutive nights during the dates specified). Once user 10 has chosen the values on the lodging preferences page, user 10 clicks on “Search” and VPS 26 will then query available properties that match the default or user chosen values.

In an embodiment of the invention, user 10 can also browse the lodging options by using a map link, allowing the user to visually relate the locations of the lodging with the activity locations. If clicked on, the map link brings up a virtual tour window (as described below) with maps for the destination (optionally with lodgings identified). The user can view their location or property of choice. Once the property of choice or location is picked from the map, the user may click “Select” which closes the Virtual Tour window, and passes the selection or location preference value to VPS 26.

In another embodiment, user 10 may browse a listing of all properties available at the destination by clicking on a “Choose by Property Name” link. By clicking on this link, the four default pull down menus described above are removed from user 10's view and two new pull down menus are revealed. One such menu is for “Property Name” listing of all properties at the destination, and the other is for “Room Type”. If user 10 chooses a particular property from the Property Name pull down menu, the second pull down menu, “Room Type” would also change to the room types available at the particular property. Alternatively, if user 10 chose “1 Bedroom” from the “Room Type” pull down menu, the Property Name pull down menu would update to the properties that have a 1 Bedroom. User 10 can also decide to change back to the original default pull down menus at any time by using the “Choose by Location” link. By clicking on this “Choose by Location” link, the four default pull down menu items would reveal and the two menu items for “Property Name” and “Room Type” would be hidden.

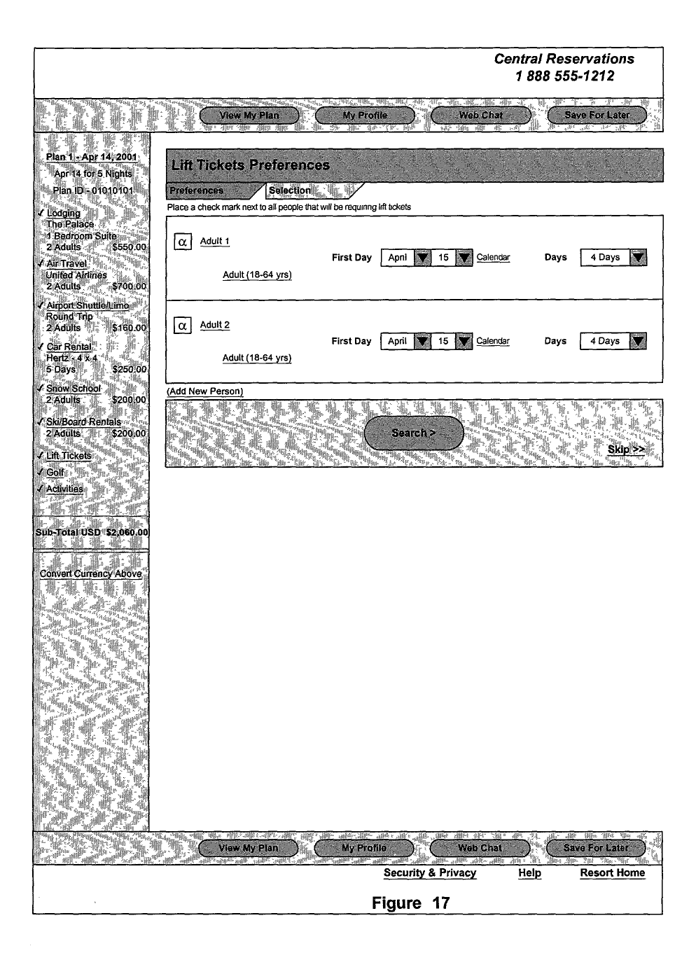

In another example, user 10 may want to purchase lift tickets for a ski resort at the destination. At the Lift Ticket Preferences page (an embodiment show in FIG. 17), VPS 26 defaults to certain values based on empirically derived industry trends. For example, those visiting ski resorts tend to ski each day they are at the resort except for the day of arrival and departure. VPS 26 accordingly defaults the lift ticket preference to lift tickets for the days between the arrival and departure dates for each member of the party. If a party member prefers less skiing, or does not want to ski at all, then user 10 may indicate such. If a member of a party does not select lift tickets, then some options (for example, ski rentals) are not made available for selection.

Furthermore, VPS 26 will use values of chosen parameters, such as age to determine appropriate activities for party members. For example, if a party member is very young child, and the other members in the party have selected lift tickets for a day, VPS 26 will default that day's activities for the child to be “Daycare”. Similarly, VPS 26, having certain values chosen for activities, will seek and present advantageous options at the destination. For example, although lift tickets, ski rentals and massage can be individually selected and priced, there may be a package deal incorporating all three activities at a discount relative to ordering and paying for each activity separately—VPS 26 will seek and obtain, in real time, for the dates and destinations chosen by user 10, intelligent options for user 10 to consider advantageously.

Optionally, in a preferred embodiment, different party members can select similar services relating to travel and lodging. For example, different party members may wish to stay at different lodgings in which user 10 will choose which party members stay at which selected lodging. Likewise, different party members may take different flights from different locations to arrive at the chosen destination, in which case user 10 selects flights for the chosen party members.

### 5. Changing Information

As can be seen from the above, and as further described below, VPS 26 uses both the information already provided it, and empirical trends in the industry to create intelligent defaults for selection or choosing, to make the travel plan development process as easy as possible for user 10. However, there will be occasions when user 10 wishes to change a selection of a service or the choice of a value of a parameter. Any change to the plan is used by VPS 26 to change both previously chosen values where appropriate and future values available for choosing. In some cases, such a change will be simple, i.e. user 10 selects a different hotel already meeting the values chosen (in which case the price of the plan will likely change, but little else).

However, in some cases, a change will be far reaching throughout the travel plan. For example, perhaps when preparing the plan, user 10 initially planned to bring a neighbor's child (identified as Child 2 by VPS 26 prior to confirmation of the plan). After developing most of the It plan, user 10 realizes that the budget does not allow for Child 2 to attend, and amends the plan by deleting Child 2 from the user profile. This change causes VPS 26 to delete all of the services directly related to Child 2 (e.g. the lift tickets, ski rental, etc.) and accordingly change the cost of the trip. Other changes may require prompting, for example VPS 26 may prompt user 10 if, given the smaller party size, a smaller lodging is preferred.

Another example of a far reaching change would be changing the dates of the plan. For example, if user 10 extends the trip by one day, VPS 26 will go through services already included as part of the plan, and prompt user 10 to determine if such services require the purchase of an extra day (e.g. another day of lift tickets, or another night's lodging). In some cases, such changes may not be available (e.g. user 10 cannot stay at the bed & breakfast selected for an extra night as it is not available for that night) and user 10 will be informed of such and prompted to make different selections.

User 10 may also add a member to the party, for example Child 2, later. That will require then prompting as necessary or appropriate. For example, user 10 will be prompted about additional services that have already been provided to the other party members, such as lift tickets for the new member.

### 6. Saving

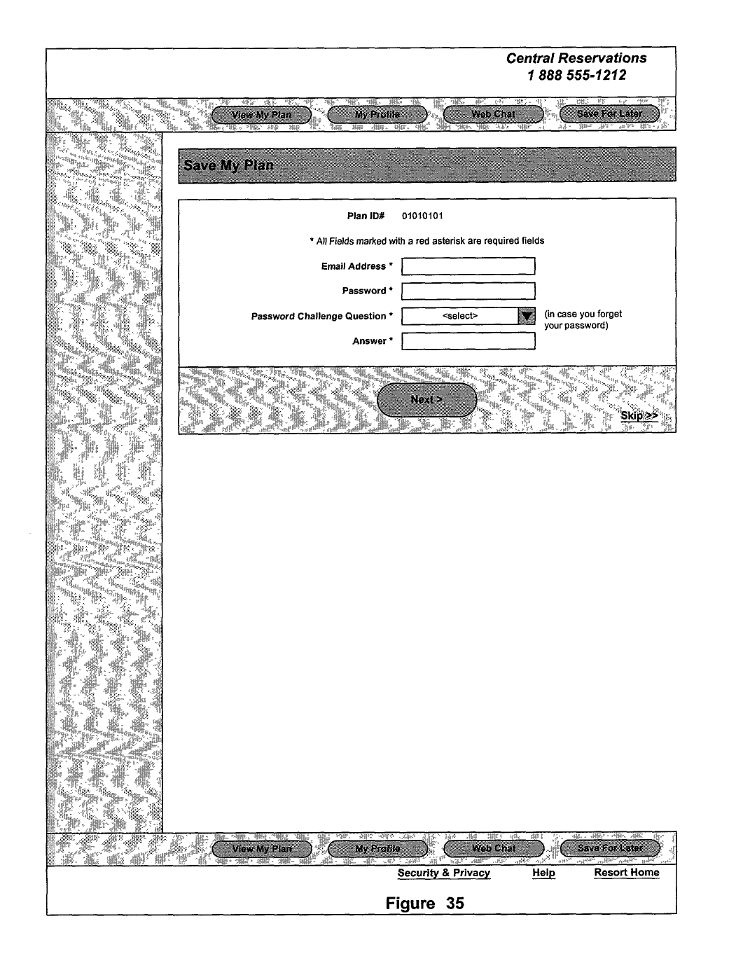

Another feature of VPS 26 is that user 10 may save completed or partially completed travel plans. To do so, in a preferred embodiment, user 10 provides an identity to VPS 26 (for example, a password and username) or VPS 26 assigns a PlanID to the plan for VPS 26 to associate with the saved plan (see FIG. 35). VSP 26 secures the travel plan by means known in the art, such as encryption or password protection, and security is “locked and “unlocked” with a “key” (whether aforementioned password; or a password or like generated by VPS 26 and provided to user 10; or keys for a public key infrastructure (PKI) system). User 10 may use the identity to create an account with VPS 26 so that upon logging into VPS 26 the next time, user 10 is presented with a list of existing saved plans (partial or complete) and an option to create a new plan. The saved plans allow user 10 to develop a draft an initial plan and then consult with family members, employers or other interested parties, before changing and/or confirming the plan at a later date.

The plans may also be saved anonymously. If no personal information has been provided to the user profile of the plan, and the identity (e.g. username and password) are arbitrarily entered by user 10 (i.e. they do not relate to user 10's true identity), there will be no information in the plan that can be used to identify user 10. Alternatively, VPS 26 may require a means of verification before saving a plan, such as a valid email address (which may or may not relatable to the true identity of user 10).

There are several advantageous processes made possible by the facility of saving a plan as described above, especially where others beyond user 10, can access, modify and confirm for themselves. For example, VPS 26 could effectively be “customized” for large groups, for example those attending a convention. User 10 (perhaps the organizer of the convention or of a group attending the convention) could prepare a partial plan, including particulars such as hotel locations and certain activities on certain dates. Each individual attending the convention could then access the plan and, for example, select their own transportation to the destination and otherwise finalize their own travel plans; all having the advantage of starting from a partial plan, preconfigured for the convention.

In a similar fashion, saved plans can be used by friends of user 10, or by user 10 more than once, for example if user 10 makes annual trips to the destination. In such a case, user 10 could access the plan saved from last year, and change only the values for the dates (as well as other desired changes) and quickly develop the new plan. VPS 26 will automatically check if the selections made previously are available in the current year and prompt for consideration as appropriate. Thus characteristics of past plans are substantially carried forward to the development of the current plan. Similarly, user 10 may save and access the user profile only, and if a person who participated in last year's trip is not participating this year, with the simple deletion of that person from the user profile, VPS 26 will automatically determine values of other parameters quickly.

### 7. Virtual Tour Window

When selecting services for the travel plan, user 10 may want to see associated images and other relevant information before making a selection. Preferably, VPS 26 displays multimedia presentations for the services available in a pop-up window interface that allows users to browse and select specific services to add to the travel plan. Such multimedia presentations include images (still and moving), text, and/or sound, including 360 degree panoramic views, live web cameras, video and cable feeds, and even discount offers and advertisements.

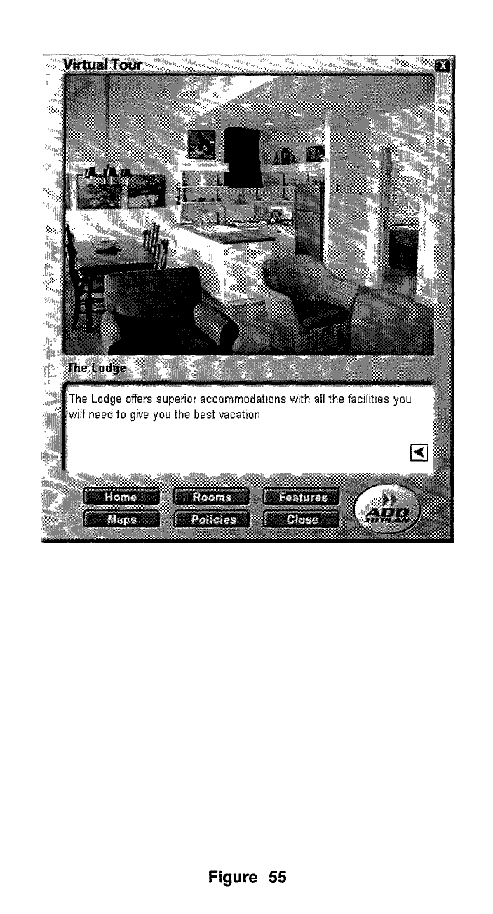

While developing the plan, user 10 will typically be presented with a list of services that meet the specified values of the relevant parameters (for example, a list of hotels that have availabilities and prices that are within chosen parameterized values). Adjacent to each hotel will be a “button” or link that can be activated to present to user 10 a “pop-up” virtual tour window containing a multimedia presentation (for example, images) associated with that particular service (as seen in FIG. 55). User 10 will be able to add the service to the plan by clicking on the “Add to Plan” button. Alternatively, user 10 may view different images or move on to a different service provider (e.g. another hotel), all from the virtual tour window (using the “Previous” and “Next” options as seen in FIG. 40).

Window Details

Each provider of a service will preferably have a virtual tour window accessible in VPS 26 of its service. Within this window, user 10 may view the services (e.g. the one bedroom room, a map of a snowmobile tour, etc.) and associated features that provide user 10 a more complete perspective on the services under consideration. The virtual tour window will also allow navigation through the list of returned items (e.g. hotels) in the main selection window via “Next” and “Previous” buttons.

Different types of virtual tour windows may be used by VPS 26 according to different services. Examples include:

Types of Windows

Property Window

Contains the following categories of media (with appropriate navigation buttons)

Rooms (e.g. a photo of the room)

Exteriors (the outside of the building)

Features (e.g. pool, restaurant)

Location (using a local map)

Policies (rules of note)

Add To Plan (to add the selection to the travel plan) or Book Now (to access VPS 26 from a web site outside VPS 26)

Golf Window

Contains the following categories of media (with appropriate navigation buttons)

Front 9 (images of the first nine holes)

Back 9 (images of the last nine holes)

Course Map

Location (relative to destination)

Features

Policies

Add To Plan or Book Now

Activity Window

Contains the following categories of media (with appropriate navigation buttons)

Features

Location

Policies

Add To Plan or Book Now

In VPS 26, the virtual tour windows are preferably accessible from the various service selection pages, such as the golf courses selection page, or an activity selection page. The following provides detailed embodiments of calls to a virtual tour window, wherein Calling Object refers to the source of the call (i.e. the user clicked on an image, a logo, an icon, text, or link; Parameters refers to the information provided; and Target Page indicates where the requested information will be found):

Hotel Selection Page:

Calling Object: Hotel Image

Parameters: VendorID, View

Target Page: Vendor Home Page (i.e. the VPS page associated with the service provider)

Calling Object: Lodging Type Text

Parameters: VendorID, View

Target Page: Vendor Home Page

Calling Object: Location Text

Parameters: VendorID, View

Target Page: Vendor Location Page

Calling Object: Room Type Text

Parameters: VendorID, ClassTypeID, View

Target Page: Vendor's Room Specific Page

Airport Shuttle/Limo Selection Page:

Calling Object: Virtual Tour Icon

Parameters: VendorID, View

Target Page: Vendor Home Page

Car Rental Selection Page

Calling Object: Car Rental Logo

Parameters: VendorID, View

Target Page: Vendor Home Page

Calling Object: Virtual Tour Icon

Parameters: VendorID, View

Target Page: Vendor Home Page

Snow School Selection Page

Calling Object: Virtual Tour Icon

Parameters: VendorID, ProductTypeID, View

Target Page: Vendor/Product Home Page

Ski/Board Rental Selection Page

Calling Object: Virtual Tour Icon

Parameters: VendorID, ProductTypeID, View

Target Page: Vendor/Product Home Page

Lift Tickets Selection Page

Calling Object: Virtual Tour Icon

Parameters: VendorID, ProductTypeID, View

Target Page: Vendor/Product Home Page

Golf Courses Page

Calling Object: Golf Course Image

Parameters: VendorID, View

Target Page: Vendor Home Page

Calling Object: Virtual Tour Icon

Parameters: VendorID, View

Target Page: Vendor Home Page

Golf Courses Selection Page

Calling Object: Virtual Tour Icon

Parameters: VendorID, View

Target Page: Vendor Home Page

Activities Selection Page

Calling Object: Virtual Tour Icon

Parameters: VendorID, ProductTypeID, View

Target Page: Vendor/Product Home Page

The Window

The virtual tour window is run from an XML document, which provides VPS 26 with the specific image hrefs (or the URL of the document to be linked to), image names, descriptions, and navigation components needed. For each piece of media, a set of XML tags describes that media. Examples of such tags (for a kitchen view, a room view and a feature view, respectively) include:

<Item Name=“1 Bedroom” ID=“1” MediaType=“image/pjpeg”>

<Description>The Lodge has a great 1 Bedroom Unit</
Description>
<Graphic>. ./. ./vps_dest/Vendors/TheLodge/1br.jpg</Graphic>

</Item>
<Item Name=“2 Bedroom” ID=“2” MediaType=“image/pjpeg”>

<Description>The Lodge has a great 2 Bedroom
Unit<Description>
<Graphic>. ./. ./vps_dest/Vendors/TheLodge/2br.jpg</Graphic>

</Item>
<Item Name=“3 Bedroom” ID=“3”MediaType=“image/pjpeg”>

<Description>The Lodge has a great 3 Bedroom Unit</
Description>
<Graphic>. ./. .vps_dest/Vendors/TheLodge/3br.jpg</Graphic>

</Item>

The virtual tour windows are accessible from three distinct areas within VPS 26:

1. From a web site outside of VPS 26 (for example, at a service provider's web site). Viewing a service provider's virtual tour window from this location gives user 10 a “Book Now” button. When pressed, the existing virtual tour window will close and pass a vendor id and product id to VPS 26 in manner similar to that of the banners described above.

2. From a Selection page. Viewing a vendor's virtual tour window from this location gives the user an “Add to Plan” button. When pressed, the existing virtual tour window will close and submit the service to the vacation plan, or if “Next” or “Previous” was pressed the next or previous selection will be displayed in the virtual tour window.

3. From a vacation sales consultant workstation. Vacation sales consultants can push web pages or send links to specific virtual tour windows to clients via a web chat applet or email.

Navigation

There are different levels of content defined within the service provider's XML file to handle navigation of the virtual tour. The navigation buttons on the virtual tour page handle the first level of content and when a button is clicked, the application returns links to the child nodes of the appropriate button category node and media tag within the current node and displays the appropriate graphic, name, and description.

The resulting list of links contains links to the child nodes of the current node. These links will further navigate to content if the current node contains child nodes other than media nodes. Each media node contains the necessary attributes to handle values passed back to the parent window. The following is an embodiment of a Service Provider XML file.

Provider XML File

<?xml version=“1.0”?>
<Group Name=“Vendor” ID=“32”>

<Item Name=“The Lodge” ID=““MediaType=“image/pjpeg”>
<Description>The Lodge could not be closer to the fun and excitement of the Village.
Restaurants, shops, cinemas and art galleries are on your doorstep. Cross the
threshold and your studio or studio loft offers the quiet and comfort so important to
the perfect vacation.</Description>
<Graphic>. ./. . /vps_dest/Vendors/TheLodge/exterior.jpg</Graphic>
</Item>

<Group Name=“Rooms” ID=““>

<Item Name=“1 Bedroom” ID=“1“ MediaType=“image/pjpeg”>
<Description>The Lodge has a great 1 Bedroom Unit</Description>
<Graphic>. ./. ./vps_dest/Vendors/TheLodge/1br.jpg</Graphic>
</Item>
<Item Name=“2 Bedroom” ID=“2” MediaType=“image/pjpeg”>
<Description>The Lodge has a great 2 Bedroom Unit</Description>
<Graphic>. ./. ./vps_dest/Vendors/TheLodge/2br.jpg</Graphic>
</Item>
<Item Name=“3 Bedroom” ID=“3” MediaType=“image/pjpeg”>
<Description>The Lodge has a great 3 Bedroom Unit</Description>
<Graphic>. ./. ./vps_dest/Vendors/TheLodge/3br.jpg</Graphic>
</Item>

</Group>
<Group Name=“Features” ID=““>

<Item Name=″Summer Exterior” ID=““MediaType=“image/pjpeg”>

</Group>
<Group Name=“Map” ID=““>

<Item name=“The Lodge Location” ID=““ MediaType=“image/gif”>
<Description>The Lodge could not be closer to the fun and excitement of the Village.
Restaurants, shops, cinemas and art galleries are on your doorstep.</Description>
<Graphic>. ./. ./vps_dest/Vendors/TheLodge/map.gif<Graphic>
</Item>

</Group>

The virtual tour system may be applied to any sort of good or service. For example, at a web site selling consumer goods such as books, DVDs, CDs and the like, a user could browse for books or DVDs, click on a link to open a virtual tour window providing a multimedia presentation (such as a trailer) about the book or DVD selected and optionally add the book or DVD to the user's shopping cart directly from the virtual tour window.

### 8. Consultant/Client Interaction

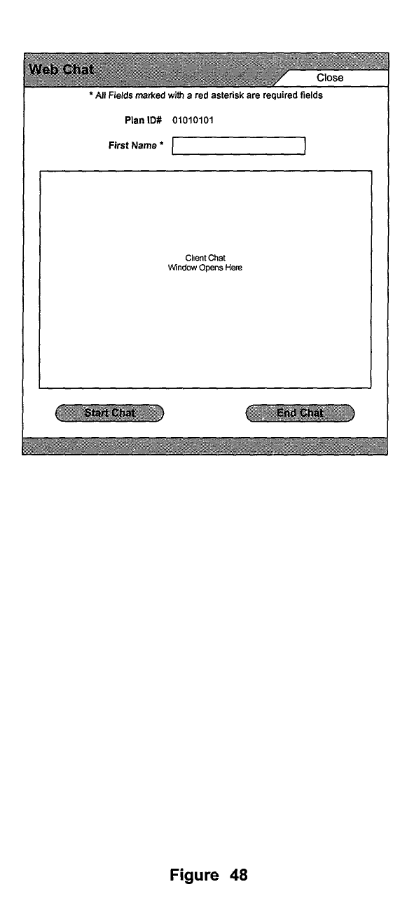

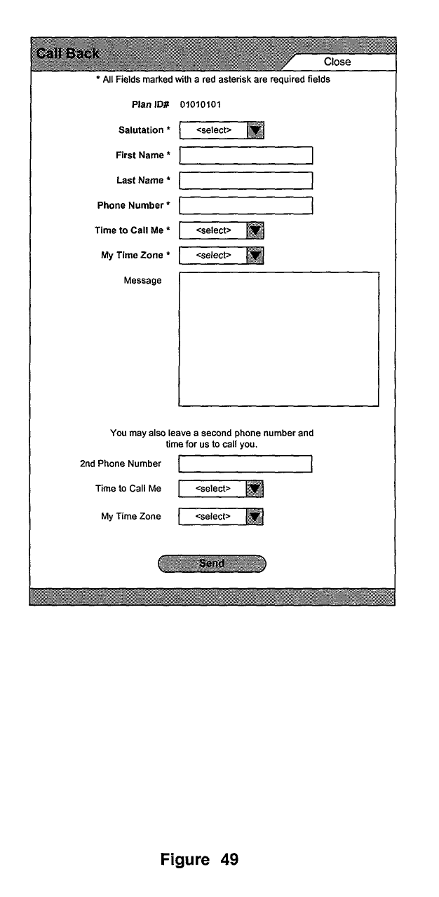

VPS 26 allows for various methods of interaction between a user 10 and a vacation sales consultant (VSC) 24. Preferably, user 10 can make a request to be contacted by VSC 24 at any point in the planning process (see FIGS. 48 and 49 for examples). Preferably, user 10 will have opted to “Save My Plan” as described above. VPS 26 will then save the plan and generate a Plan ID. Once a Plan ID is generated, user 10 then has several options on how to be contacted by VSC 24. For example, user 10 may indicate a preference to be contacted by email, web chat, or telephone (either immediately or at a user specified time and date). User 10 could also call the 1-800 number that is preferably placed on every page in the header graphic at VPS 26, that when called, will route the call to a specific call center (preferably based on destination) and the next available VSC 24 assigned to answer calls for that destination. Requests to contact a VSC 24 made via VPS 26 (for example, by chat, or email) will be routed to the appropriate VSC 24 if user 10 has already communicated with a VSC 24.

VSC 24 has the ability to assist user 10 in many different ways, including the following:

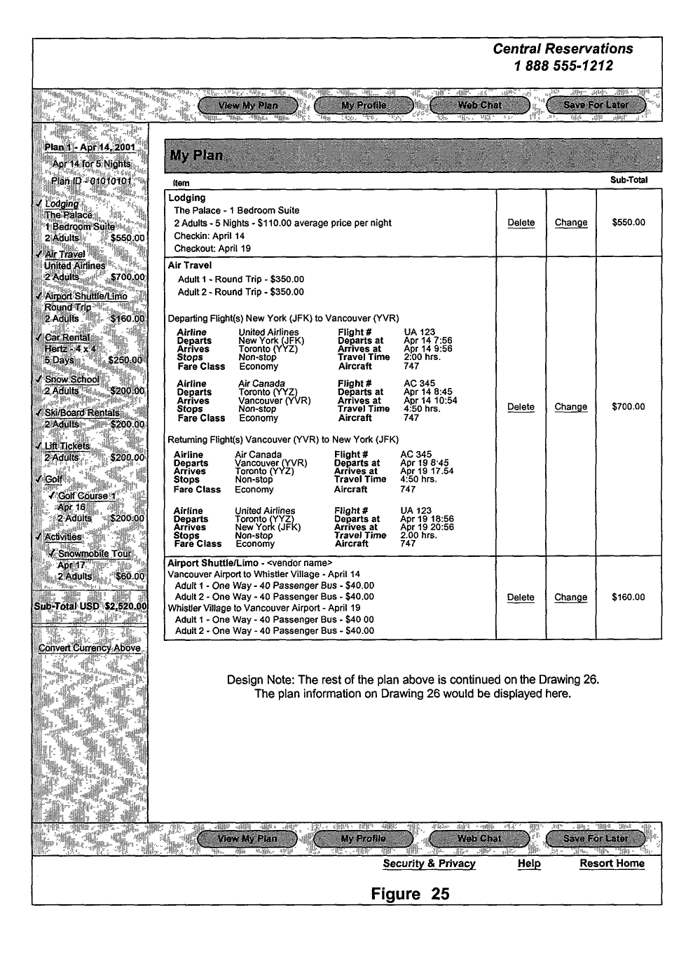

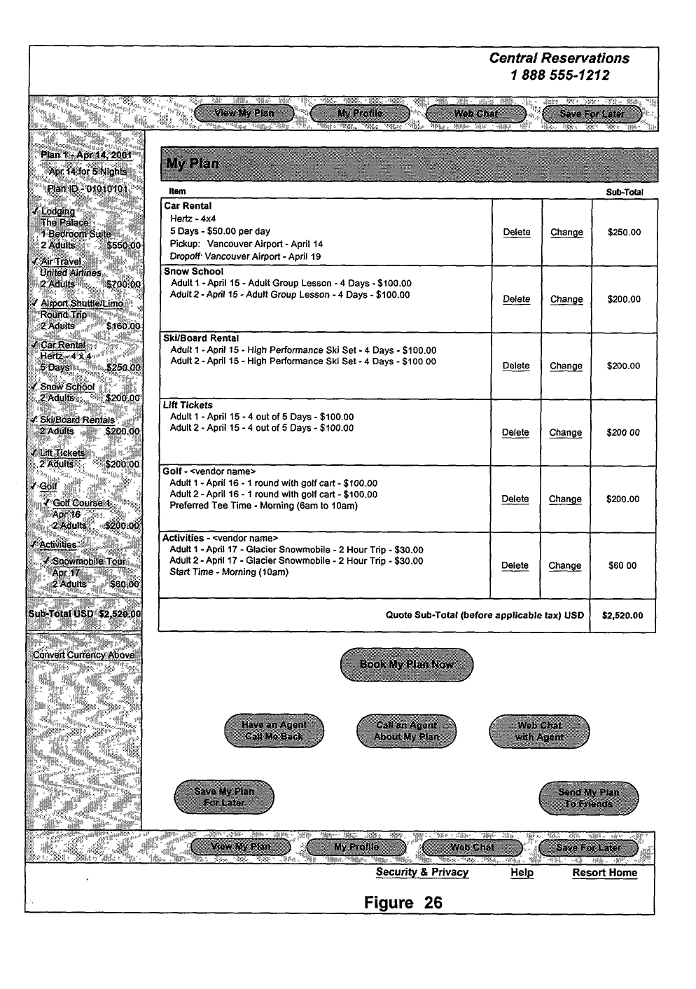

(a) Update a Plan—VSC 24 could access and change a user's saved plan and then save the updated plan. The updated plan would then be instantly available for viewing by user 10 using a password and username. For example, user 10 partially develops a plan, saves the plan, calls the call center and gives the VSC 24 the Plan ID. VSC 24 could perhaps recommend a different hotel at a better price that just became available and amends the plan accordingly. VSC 24 then saves the amended plan and tells user 10 on the phone to reload the “My Plan” page (see FIGS. 25 and 26). User 10 would see amended plan with the new hotel. The VSC 24 could then instruct user 10 to look at the change and to look at the virtual tour window for the new hotel in the plan and ask user 10 if the new hotel is suitable.

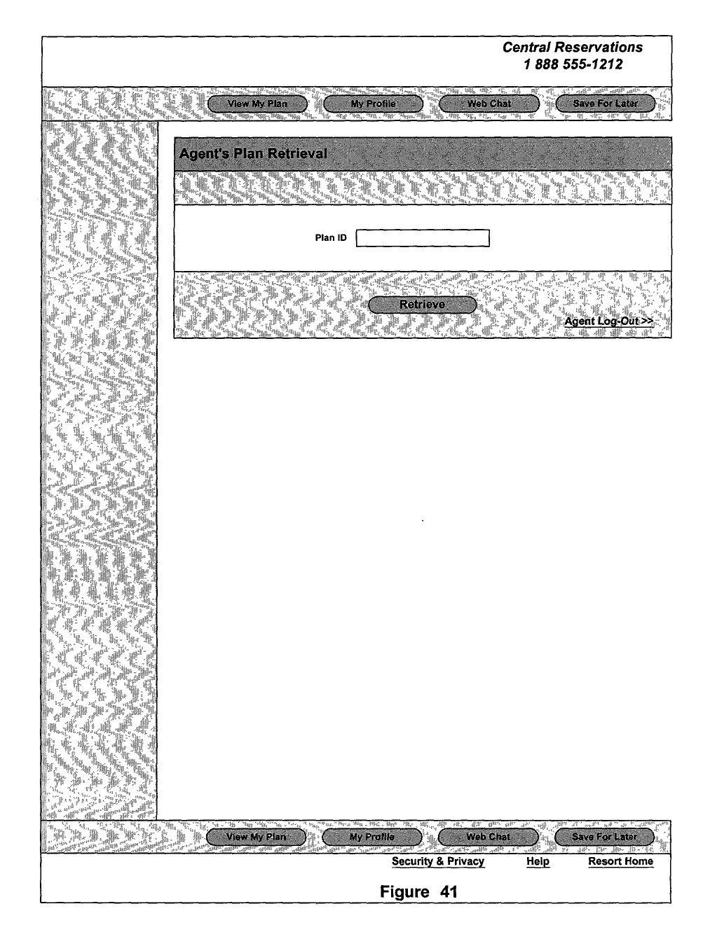

(b) Update a Plan from the VPS—VSC 24 may have a private secured login to enter a Plan ID in the VPS and make changes as if he were user 10 (see FIG. 41). The VSC 24 would only do so if user 10 requests or needs assistance in using the VPS 26 or in changing or completing the plan. VSC 24 would login using the Plan ID and then would make changes or complete the plan for user 10. VSC 24 could do this while on the phone with user 10 or make the changes and then contact user 10 via email and instruct user 10 to login to VPS 26 and see the amended plan.

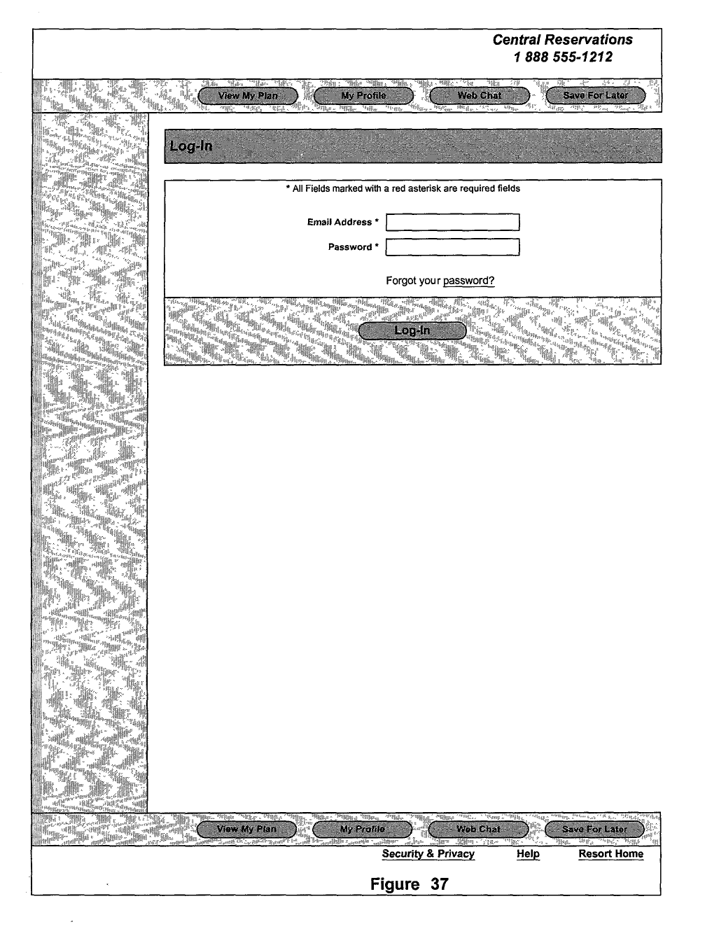

(c) Create a Plan—VSC 24 could create a new plan in the VPS 26 for a user 10 that has requested a travel plan (typically via telephone). VSC 24 would ask user 10 for an email address and assign user 10 a temporary password. VSC would then instruct user 10 to log in to VPS 26 with the email address and the temporary password (see FIG. 37). User 10 would then be able to immediately see the services in the travel plan and also take advantage of the virtual tour windows that would be available for such services. VSC 24 could tell user 10 to review parts of the plan, make any amendments user 10 wishes to make and take other instructions from user 10.

(d) VSC 24 could also amend a travel plan when in a web chat session with a user 10. For example, user 10 launches a web chat session and the session (with the PlanID) is routed to a VSC 24. VSC 24 could then amend the plan based on instructions from user 10. Once a change is made by VSC 24, user 10 can reload the pages by clicking on “reload” on their web browser and the changes are then available to user 10.

A further use of VPS 26 is to serve as a means for training a VSC 24 such as a travel agent. It can be difficult for a VSC 24 to provide advice and recommendations about traveling to a destination, if VSC 24 has not been to such destination. By using VPS 26, VSC 24 can view maps and other information (such as multimedia presentations via the virtual tour windows) relating to the destination and get a better idea of what services are available to VSC 24's clients.

The above examples demonstrate ways in which VPS 26 allows for interactivity between VSC 24 and user 10 to make development of travel plans as simple as possible for user 10. Furthermore, VSC 24 may be located anywhere, for example VSC 24 could work from home or any other remote location. Other networks and ways of transferring plans and related information include wireless, intranets, extranets, and PDAs.

### 9. Service Providers

Service providers are entities that provide services to vacationers that may be confirmed via VPS 26 and that form part of a travel package. As seen in FIG. 51, service provider 32 may have direct access to VPS 26 to efficiently provide information to, and obtain information from VPS 26. The operator of VPS 26, who is typically a party that aggregates such services in a package for sale, can offer the service providers a customized version of VPS 26 for use at the service provider's web site to allow that provider to sell its service directly to users as part of a package with other non-competing services sold through VPS 26. The preceding relates to service providers for the travel industry and is only illustrative of the service provider that this invention's VPS 26 can be used collaboratively with. Of course, there are many other types of goods or service providers for other industries (e.g. personal computer systems, health and fitness programs, wedding and reception functions) that are applicable.

Examples of applications that may be made available to such service providers include:

VPS Service Provider Labeled Website

A VPS Service Provider labeled website allows access to a private labeled version of VPS 26 via the service provider's web site. Such a private labeled version of the VPS 26 may allow users 10 only to select the provider's particular service along with the other non-competing services available via VPS 26. For example, if the service provider 32 is a hotel, the private labeled VPS 26 accessible from that hotel's web site would provide the normal choice of services except for that of lodging which would have only the service provider's hotel (or related lodgings). The service provider 32 and VPS 26 operator may determine an appropriate way to share revenue from a user of such private labeled web site, for example, the operator may provide the private labeled VPS 26 to the hotel at no charge (or at a minimal charge), the hotel may keep all revenue associated with the hotel services, while the operator retains the remainder of the revenue. Other revenue sharing arrangements known in the art are also available.

The application described above is applicable to many other industries besides the travel industry. For example, many computer retailers sell computers via the Internet. Computers are a package of goods, as they include many different goods provided by different parties (e.g. the retailer may sell computers having hard drives from a hard drive maker). The retailer could provide the hard drive maker with software enabling the hard drive maker to sell computers at its web site, or direct users to the retailer's web site, and in either case, such users would have their choice of hard drive in the computer purchased via the site limited to those from the particular hard drive maker.

VPS Service Provider—Setup Services

The VPS 26 operator may provide service provider 32 with a web application to allow the provider to create and manage its services that are available via the VPS 26. Such an application may for example, allow service provider 32 to update prices, change text, and update and change multimedia presentations relating to its services.

VPS Service Provider—Setup Inventory

In most cases, VPS 26 operator may provide service provider 32 with a web application that allows service provider 32 to manage inventory sold through VPS 26. Such an application may allow the provider to maintain a real time inventory. This prevents such problems as double booking, and allows VPS 26 to operate with real time availability of services (for example, if a hotel is fully booked on a certain date, it will not appear for selection if user 10 wishes lodging on such date).

VPS Service Provider—Reporting

VPS 26 operator may provide service provider 32 with a web application that provides service provider 32 with real-time statistical reporting relating to sales of services and the like.

VPS Service Provider—Reservation Control

VPS 26 operator may provide service provider 32 with a web application that allows the provider to manage reservations confirmed through VPS 26. This allows service provider 32 to update its records in real time based on information received and plans confirmed through VPS 26.

By using a combination of the above-listed applications with service providers, VPS 26 will be able to provide a real time reservation system to users 10. This avoids a double booking problem that can occur if there are time lags between the reservation and the recordal of that reservation with the service provider. Likewise, the service provider can maintain efficiency by making services available on VPS 26 as soon as they are available in its own system (for example because of cancelled reservations). The availability and cost of the services can also then be determined by the values of parameters provided by user 10. For example, if in a hotel, the room type desired by user 10 is not available for the week user 10 intends to travel to the destination, that hotel will not be available for a user choosing such value for the parameters. The above communications between VPS 26 and service provider 32 may be accomplished by direct connections between VPS 26 and the service provider's inventory control system or through network 22. This system also allows information about party members to be shared between VPS 26 and service provider 32 to aid in providing efficient service (e.g. ensuring appropriately sized rental skis are available when needed).

### 10. Entry Points

Access to VPS 26 will preferably come from a variety of sources. For example, banners can be distributed in various locations on the web, and service providers will have incentives to allow users access to private labeled versions of VPS 26 and virtual tour windows of its services. With the exception of links directly to a web site operated by VPS 26, most users accessing VPS 26, will be doing so after having already chosen values for certain parameters to pass to VPS 26 via banners, virtual tour windows or private labeled versions.

For example, users clicking on the banners will pass information as described above to VPS 26, such as destination, arrival date and number in the travelling party. Users accessing VPS 26 via a service provider web site (for example via a virtual tour window), will default to select the service provided by the service provider (and may have no other options in VPS 26 available for that particular service).

### 11. Summary Bar

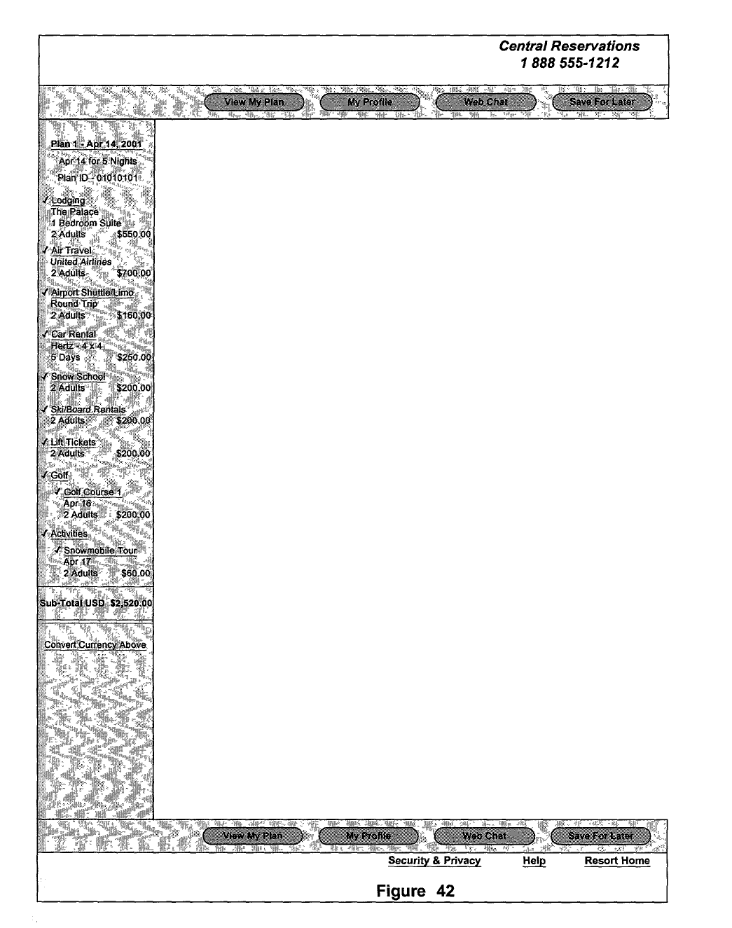

In a preferred embodiment, on the left side of each web page in VPS 26 is a summary bar, as seen (isolated) in FIG. 42. Summary bar serves a dual function as a “shopping cart”, in that it provides user 10 with a summary of the services user 10 has selected, the price of each such service (and their total price) and as a navigation system, in that user 10 can navigate through categories of services available in VPS 26 by using summary bar. The “navigation” function is provided by summary bar preferably: (i) displaying categories of the services already selected for the travel plan and those for which services have not yet been selected; (ii) indicating the current category of service in which the user is making selections; and, (iii) serves as a navigation tool by which user 10 can access different web pages in VPS 26 to obtain information about and add services (or change services already added) to the plan, by clicking on service category name or a particular service listed.

As a “shopping cart” the summary bar displays (i) a short description of services already selected in each category of services; (ii) the price of the services selected in each category of service; and (iii) the total price of the plan based on the selected services.

In a preferred embodiment, at the top of the summary bar is a header displaying information such as the travel plan name (which can be edited by user 10) and beginning date of the trip. Below the header is a section for the different categories of services applicable to the plan. Each category preferably displays the following items:

A link to the web pages for that service. If the user has selected the service, the service selection page will be displayed; otherwise the appropriate web page will be provided to allow the user select the service.

An identifying mark such as a check mark, to indicate whether user has already added the service to the plan. As the user goes through the planning process, once a service is added to the plan, a check mark will be displayed beside such service. In an alternative embodiment all services selected by user 10 in the vacation preferences page will be displayed with a check. Services not selected may still be accessed by user 10.

A brief description of the selected service.

A description of the party members who have confirmed the service (e.g., 2 adults and 3 children).

The total price of the service for all party members.

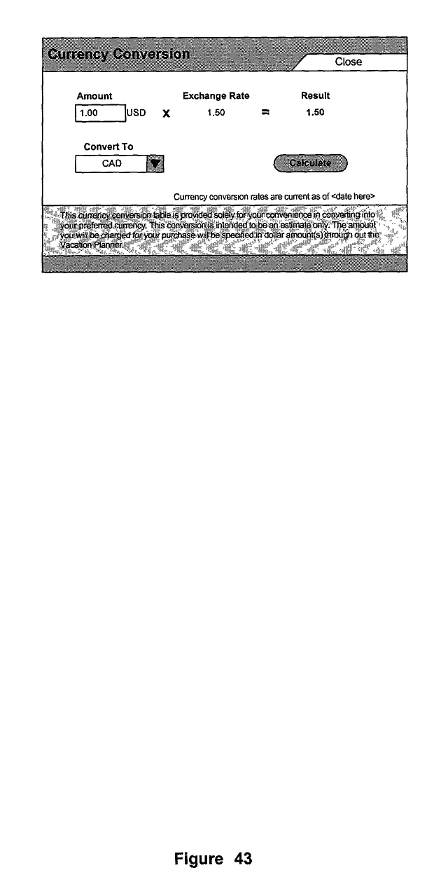

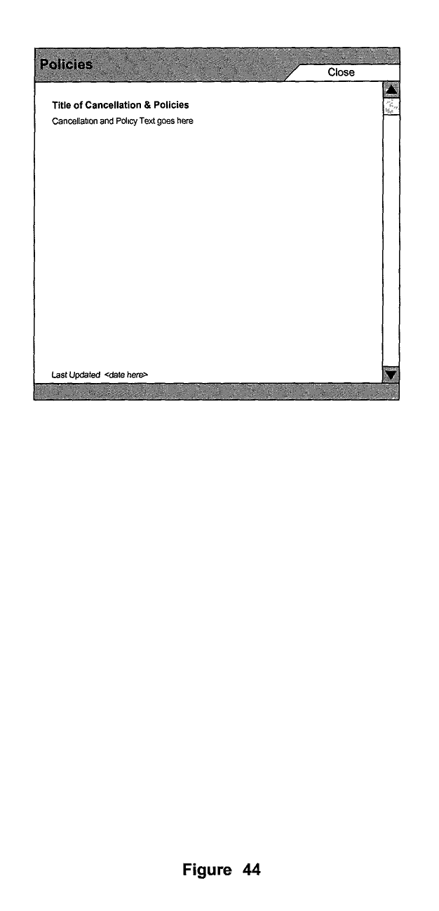

At the bottom of the summary bar, the total price of the selected services is provided in the currency in which the quote is based (alternatively, user 10 can use the pop up window currency converter as seen in FIG. 43). VPS 26 preferably has a currency choice, allowing user 10 to develop a travel plan based in user 10's local currency, and confirm and pay for such trip in that currency (VPS 26 may alternatively require payment in the currency of the service provider's selection). User 10 may thus receive the travel plan quote in the currency of choice.

The summary bar also provides a useful tool for user 10 to step through the planning process by clicking on the categories in the order in which they appear on the summary bar, although summary bar also provides user 10 means to link to different web pages in VPS 26. In normal use of VPS 26, user 10 will be guided through the categories in the order presented in summary bar, by interacting with VPS 26, although user 10 can deviate from this path at any time by using summary bar. If the travel plan is saved and later reaccessed, the summary bar will provide a quick summary of the selected services and VPS 26 will resume the plan development where user 10 last left off.

The summary bar has uses in other industries besides travel. For example a web site for purchasing consumer goods, such as books, CDs and DVDs could have such a bar using the different categories of goods available at the site. The summary bar would serve as a shopping cart by indicating the purchases made in each category and the price thereof (as well as the total price). The user could navigate through the site by clicking on the category links.

### 12. An Example of use of the VPS

In an example embodiment for the preferred embodiment, user 10 can access VPS 26 by clicking any Destination Banners, Destination Date Banners or Destination Detail Banners (as seen in FIGS. 1 to 3) which may be placed on web sites throughout the network 22. On clicking any of these banners, the “Vacation Planner” preferences page, as seen in FIG. 4, is presented. The “Vacation Planner” preferences page contains three categories of parameters: “My Dates”, “My Choices” and “My Party”. To begin creating a travel plan, user 10 makes choices from the parameters in the “My Dates” and “My Party” categories, and should make a choice about at least one of the parameters in the “My Choices” category, and then clicks “GO” to continue to the next page.

As may be seen in FIG. 4, the “My Dates” category contains a “Start Date” parameter, comprised of two sub-menus, one for choosing the month and the other for choosing the day, and “# Nights” parameter for choosing the desired number of nights at the destination. The “My Party” category has the three parameters of “Adults”, “Seniors” and “Children”, from each of which user 10 should choose a numerical value equal or greater than zero. If user 10 enters a number greater than zero for the number of children, user 10 will be prompted to enter an age for each child.

In general the parameters in the “My Choices” category are determined according to the destination chosen by user 10. Preferably, only those parameters that are relevant to the chosen resort are displayed. Further, the choices made by user 10 from the “My Dates” category, namely the start date and the number of nights, will determine whether any values for a particular parameter are available during the dates chosen by user 10. If no values are available for the particular parameter, for example because the activity associated with the date parameter is out of season, that activity will preferably be disabled and therefore displayed differently from the other parameters, for example in shaded form.

As seen in FIG. 4, as an example, the “My Choices” category contains the following parameters: “Hotel/Lodging”, “Air Travel”, “Airport Shuttle/Limo”, “Car Rental”; “Snow School”, “Ski/Board Rentals”, “Lift Tickets” “Golf Tee Times” and “Activities/Events”.

User 10 chooses the desired values from “My Choices”. Each value is associated with other parameters that will be displayed on later web pages. The values available for each such other parameters will also be determined by the destination and the values chosen in the “My Dates” and “My Party” parameters. User 10 may make a choice from the values available for each such other parameter in the menus displayed at the appropriate web page. If any of the parameters are common among two or more main parameters, such as dates for ski lift tickets and ski rentals, it will be used in determining the default values of each.

When user 10 has chosen the value for the parameter “Hotel/Lodging”, and clicks the “Go” button, user 10 will be led to the “Lodging Preference” web page, as seen in FIG. 5, containing the parameters “Adults”, “Seniors”, “Children”, “Age” (of children), “Location”, “Lodging Type”, “Room Type” and “Price Range”. User 10 will also be given the option of, instead of making choices for each of the last four aforementioned parameters, choosing lodging by property name, in which case user 10 only chooses values for the parameters “Property Name” and “Room Type”.

The values for the parameters “Adults”, “Seniors” and “Children” and “Age” (of children) are set to defaults based on the choices made by user 10 previously. User 10 has the option of leaving the default values as they are or changing the values by entering new values for a parameter. User 10 may also choose a value for each of “Location”, “Lodging Type”, “Room Type” and “Price Range” parameters; or alternatively the “Property Name” and “Room Type” parameters, failing which the default values of no preference will be used.

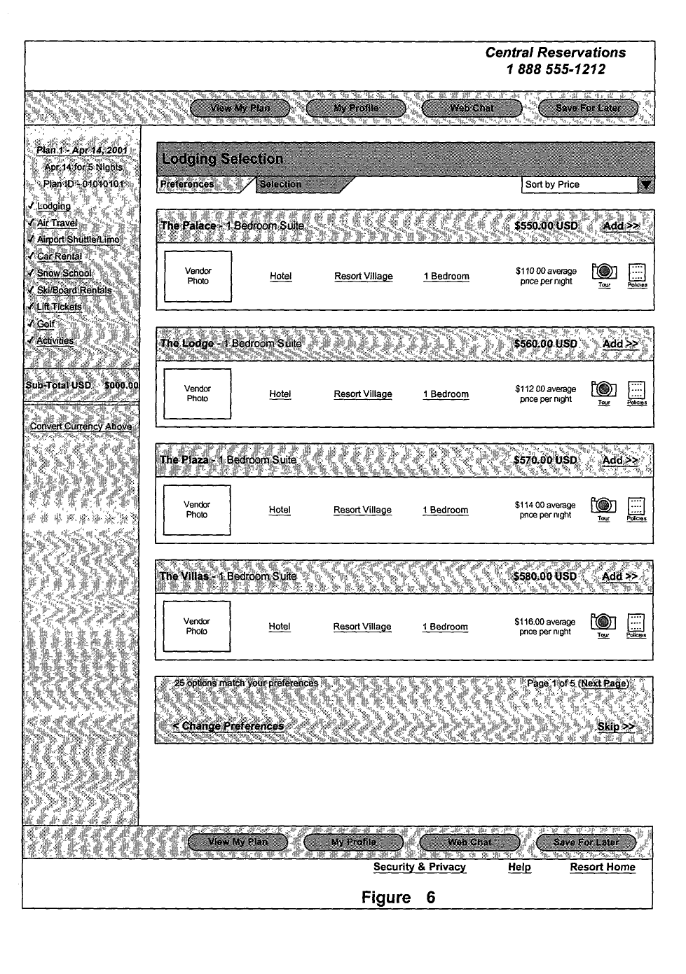

Once user 10 chooses a value (or accepts the defaults) for each of the lodging parameters, user 10 will be able to see the services available meeting the values of the parameters by pressing the “Search” button on the “Lodging Preferences” page. For each available service for lodging, in addition to its name, its specifications (such as type, location and average price per night), and the total price for the duration of the stay, are displayed on the “Lodging Selection” screen (as seen in FIG. 6). A thumbnail photo of each available lodging will appear on the screen, which user 10 can enlarge and view (as described above) in a virtual tour window, and a “Tour” button on the screen for each available lodging will allow user 10 to open a virtual tour window for the specific lodging. The virtual window tour, (examples seen in FIGS. 40 and 55), includes buttons for viewing “Rooms” “Features” “Maps”, and “Policies” of a particular lodging and may include a “Home” button that takes user 10 to the homepage of the website for the particular lodging, and a “Close” button which closes the virtual tour window. The virtual tour window also has a “Add to Plan” button that allows user 10 to add the particular lodging to the plan from the virtual tour window. If user 10 presses the “Add to Plan” button and selects the particular lodging that lodging will be added to user 10's travel plan, and user 10 will be taken to the next service preferences web page based on the choices from the “Vacation Planner” preferences web page and the summary bar will be updated accordingly. Otherwise, once finished with reviewing the particular lodging, if user 10 decides not to select the particular lodging, at least at that point in time, user 10 will press the “Close” button to go back to the “Lodging Selection” page.

Back on the “Lodging Selection” web page, user 10 also has the option of going back to the “Lodging Preferences” web page by clicking the “Change Preferences” button and changing the chosen values for the various parameters. User 10 can select a lodging by pressing the “Add” button related to that lodging. Once user 10 selects a lodging, or alternatively decides not to make a selection by pressing the “Skip” button at the end of the “Lodging Selection” web page, user 10 will be led to the next applicable preferences web page.

In a preferred embodiment, another parameter from the “My Choices” category that user 10 can choose is “Air Travel”, which when chosen, will lead user 10 to the “Air Travel Preferences” web page, as seen in FIG. 7. This page contains preference parameters “Adults”, “Seniors”, “Children”, “Age” (of children), “From”, “Departure Date”, and “Time”, “Return Date” and “Time”, “Airline” and “Fare Class”. The default values for the first four parameters, and “Departure Date” and “Return Date” will be determined from the values chosen previously by user 10. Further, as before, user 10 has the option of overriding the determined values.

User 10 may choose a “Time” for departure and a “Time” for return from the provided menus. User 10 may also choose the “Airline” and “Fare Classes” from the provided menus, failing which the default value of any airline and any fare class will be used. User 10 can have all the available services for the “Air Travel” parameter based on user 10's preferences displayed on the “Air Travel Selection” web page by pressing the “Search” button, or go to the next appropriate preferences web page by clicking the “Skip” button.

On clicking the “Search” button, the departing flights and returning flights matching the values chosen by user 10 will be displayed on the “Air Travel Selection” web page, as seen in FIG. 8. The available flights are grouped by price, with flights from the same airline at the same package price grouped together, with departing flights above and the returning flight below. The logo of the airline appears on the web page beside the flights of that airline, which may be clicked for user 10 to access a virtual tour window for such airline. For each of the flights, the departure date and time and the arrival date and time (in local time), the number of stops and the duration of the flight will be displayed. The details of each flight can be displayed by clicking the “Details” button next to the particular flight. User 10 also has the option of viewing a virtual tour and policies of the airline offering the available flights by clicking the “Tour” or “Policies” buttons respectively. Each flight can be “selected” by clicking the circle beside it. User 10 can then add the selected flight or flights to the travel plan by pressing the “Add” button. User 10 can also return to the “Air Travel Preferences” web page to change air travel preferences by pressing the “Change Preference” button, or can skip Air Travel Selection and go to the next applicable preferences web page by pressing the “Skip” button.

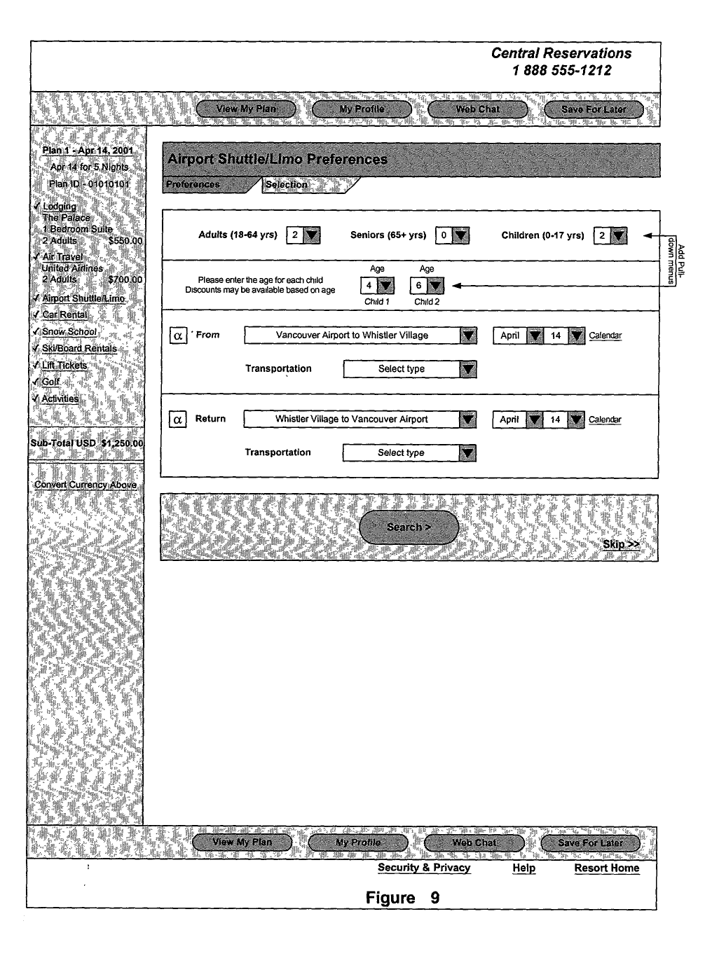

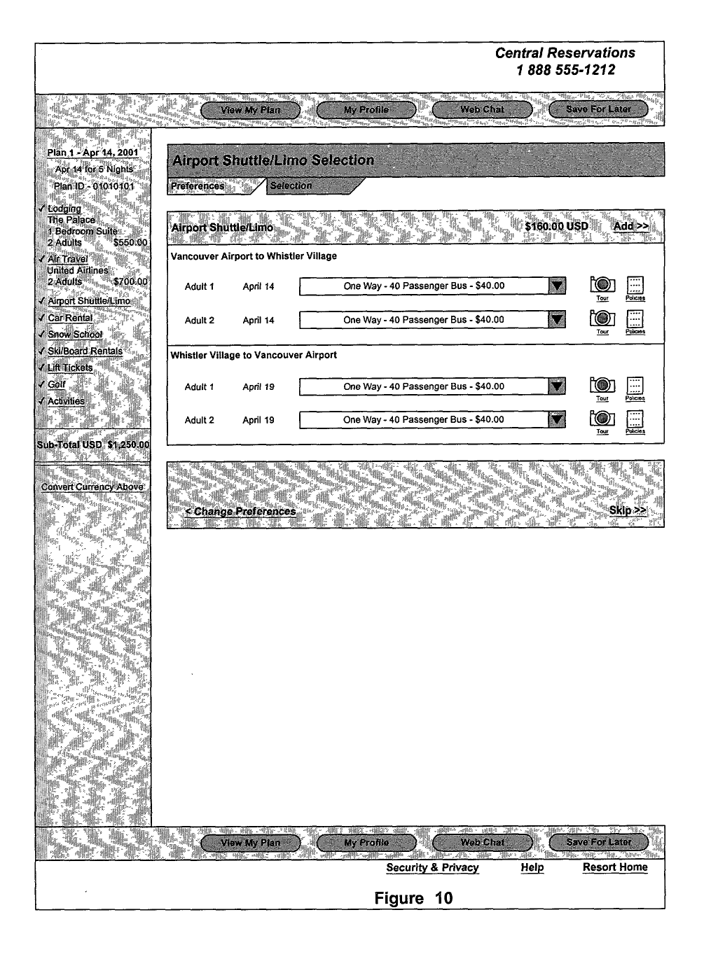

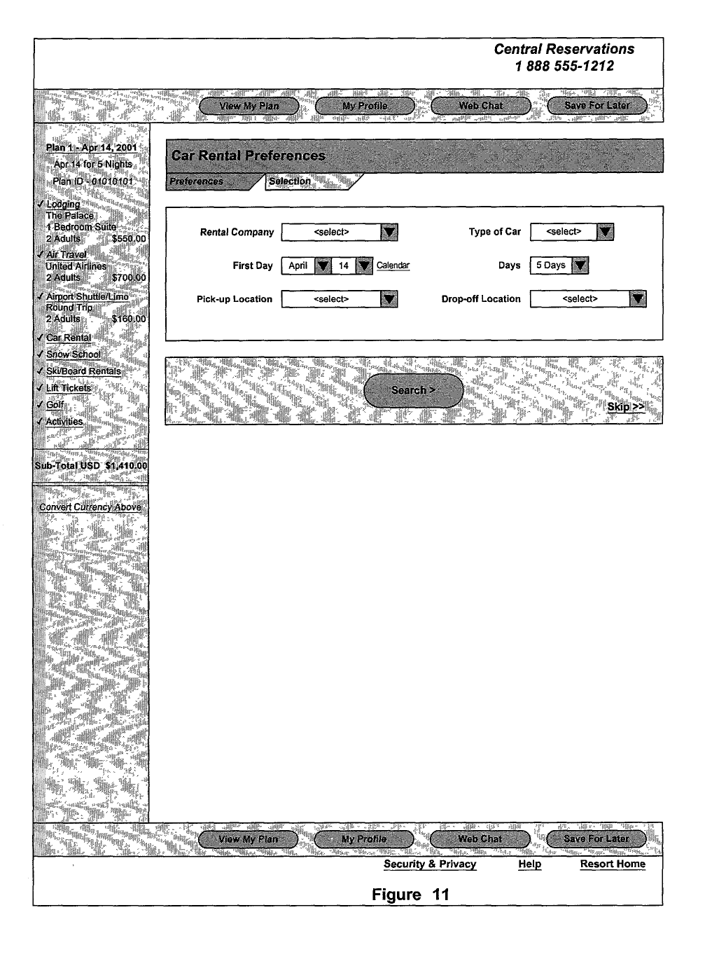

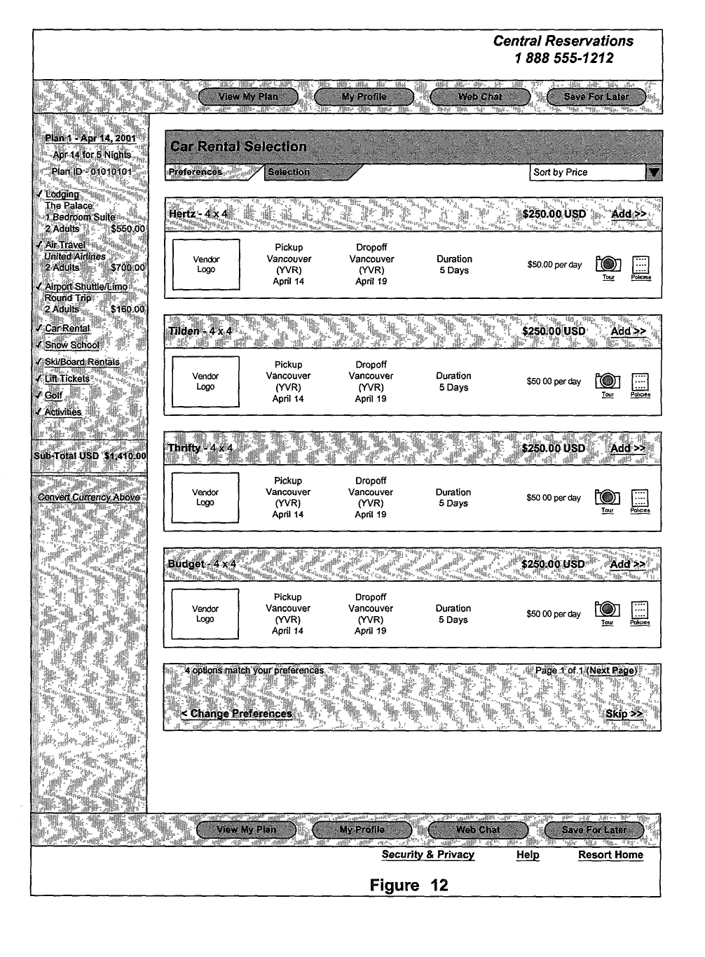

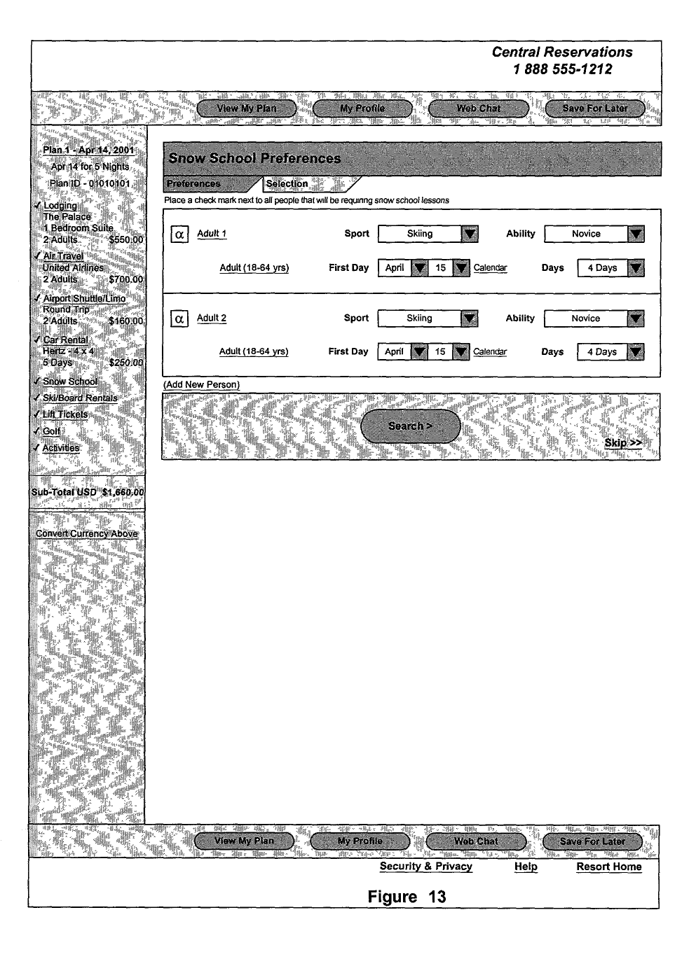

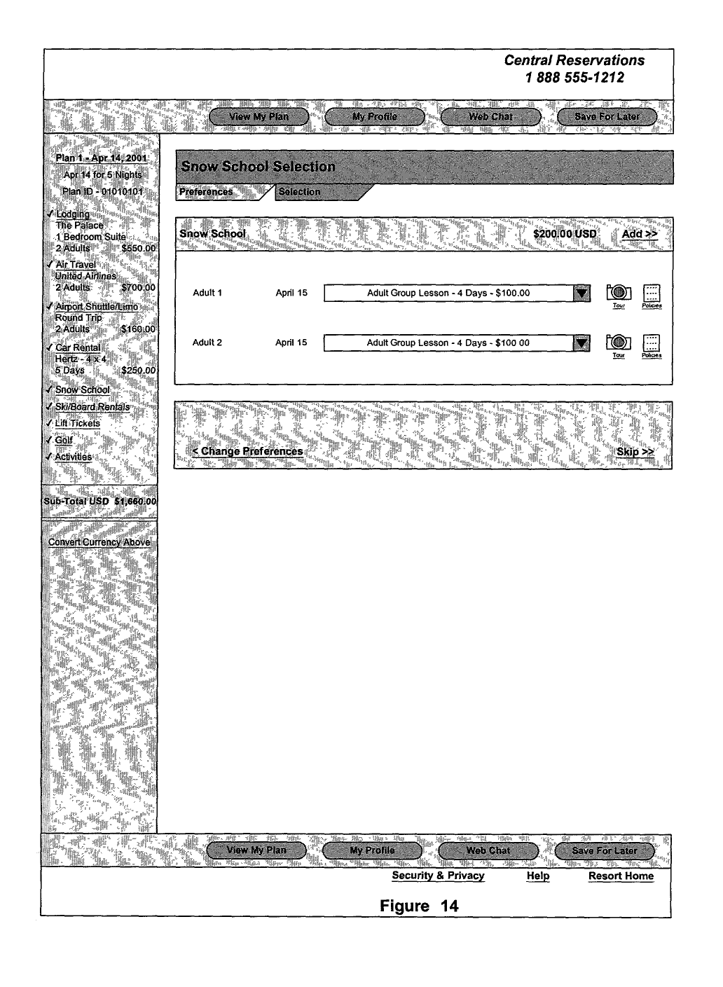

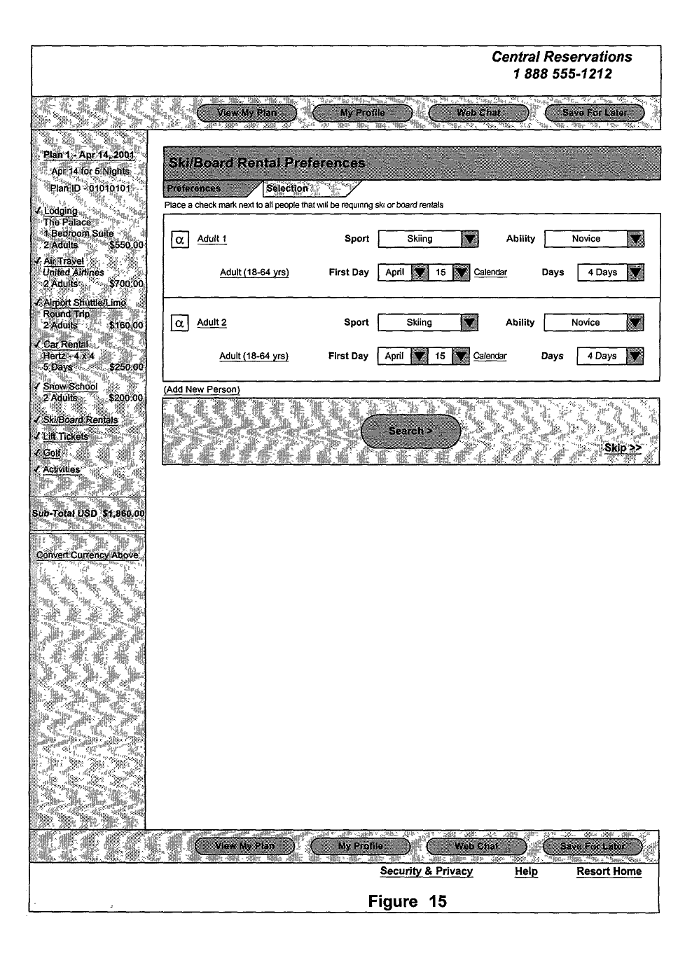

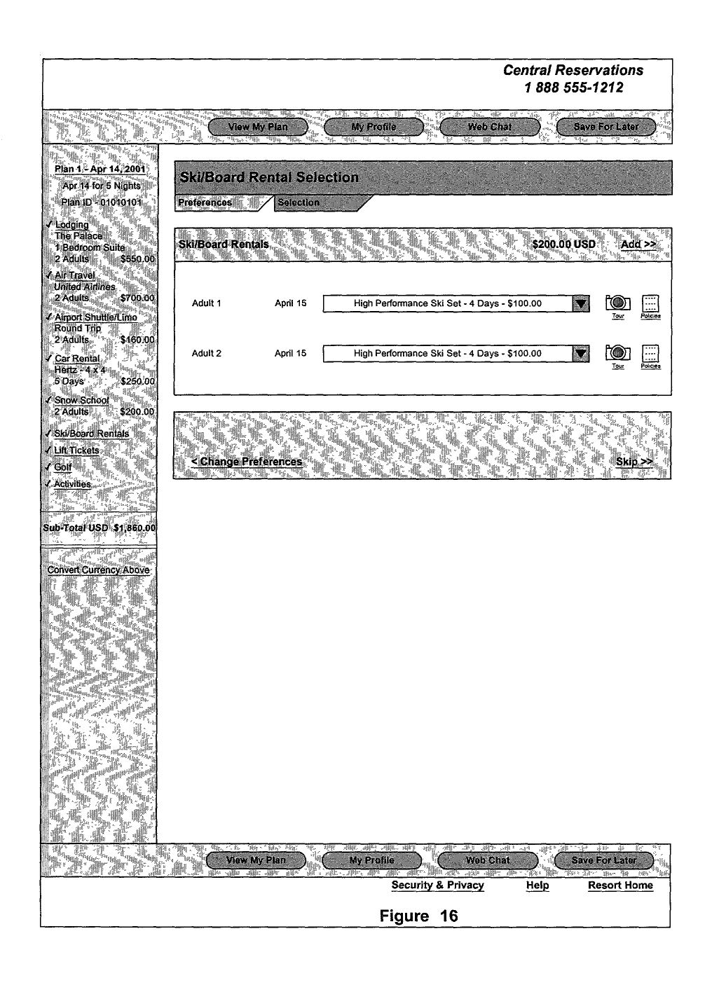

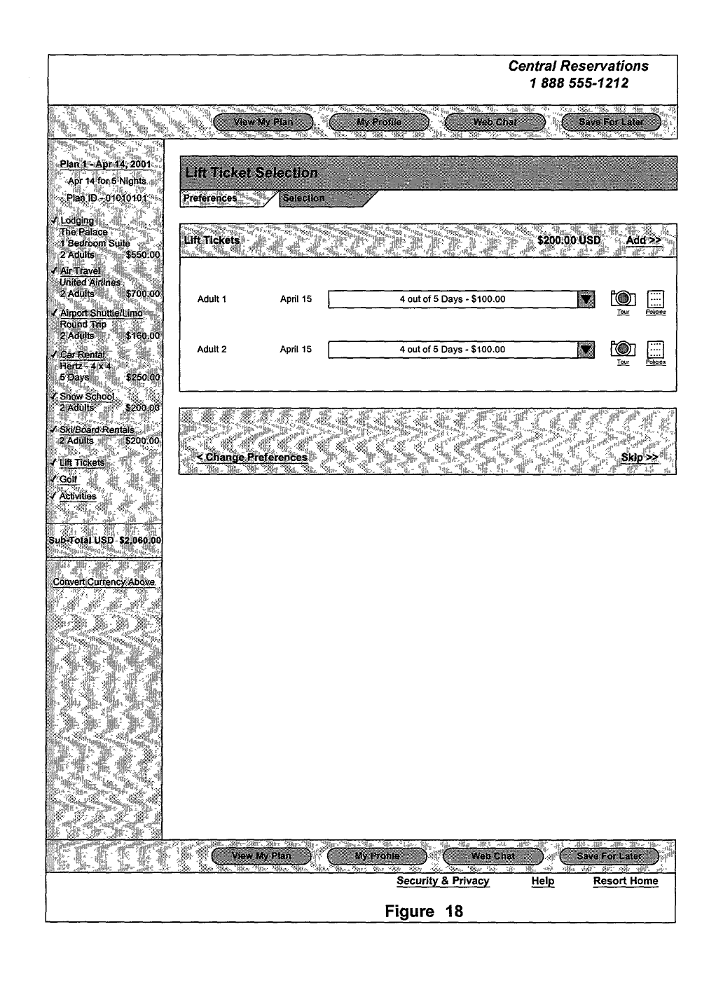

As seen in FIG. 4, in a preferred embodiment, other parameters from the “My Choices” category that user 10 may choose are “Airport Shuttle/Limo”, “Car/Rental”, “Snow School”, “Ski/Board Rental”, “Lift Tickets”, “Golf” and “Activities”. Similar to “Hotel/Lodging” and “Air Travel” parameters, “Airport Shuttle/Limo”, “Car/Rental”, “Snow School” and “Ski/Board Rental” parameters are chosen by user 10 in a two step process, where, in the first step, user 10 chooses (or accepts default) values about the individuals in user 10's party who are to use the service. In the second step, based on user 10's choices in the first step (and previously chosen values), the values available for each parameter will be displayed on the web page for user 10 to review and/or select from. Examples of these two-step selection processes may be viewed on the following web page pairs: “Airport Shuttle/Limo Preferences” and “Airport Shuttle/Limo Selection” web pages (FIGS. 9 and 10); “Car Rental Preferences” and “Car Rental Selection” web pages (FIGS. 11 and 12); “Snow School Preferences” and “Snow School Selection” web pages (FIGS. 13 and 14); “Ski/Board Rental Preferences” and “Ski/Board Rental Selection” web pages (FIGS. 15 and 16); and “Lift Tickets Preferences” and “Lift Tickets Selection” web pages (FIGS. 17 and 18).

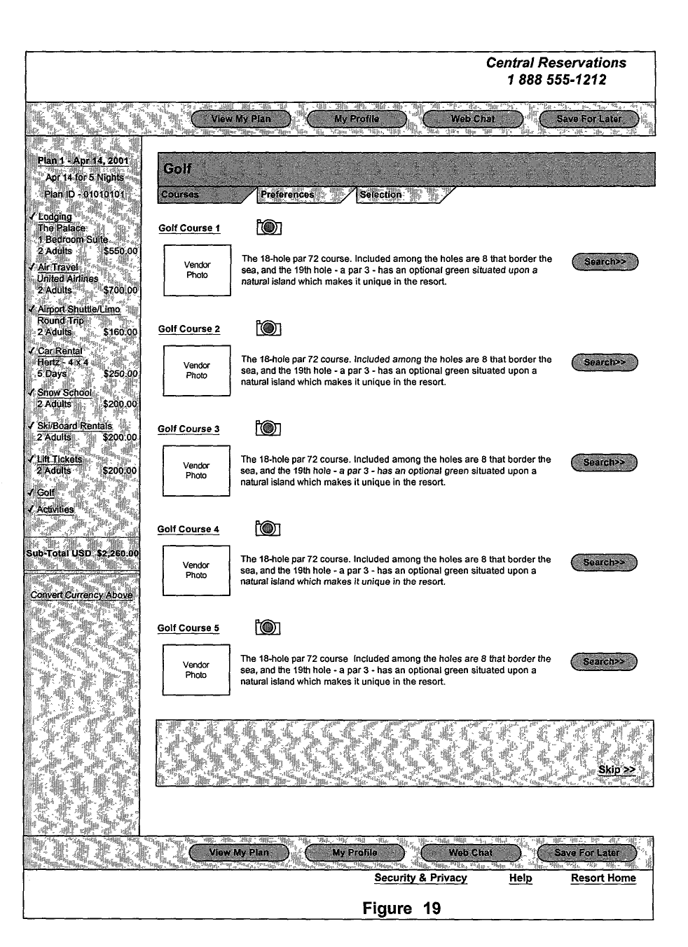

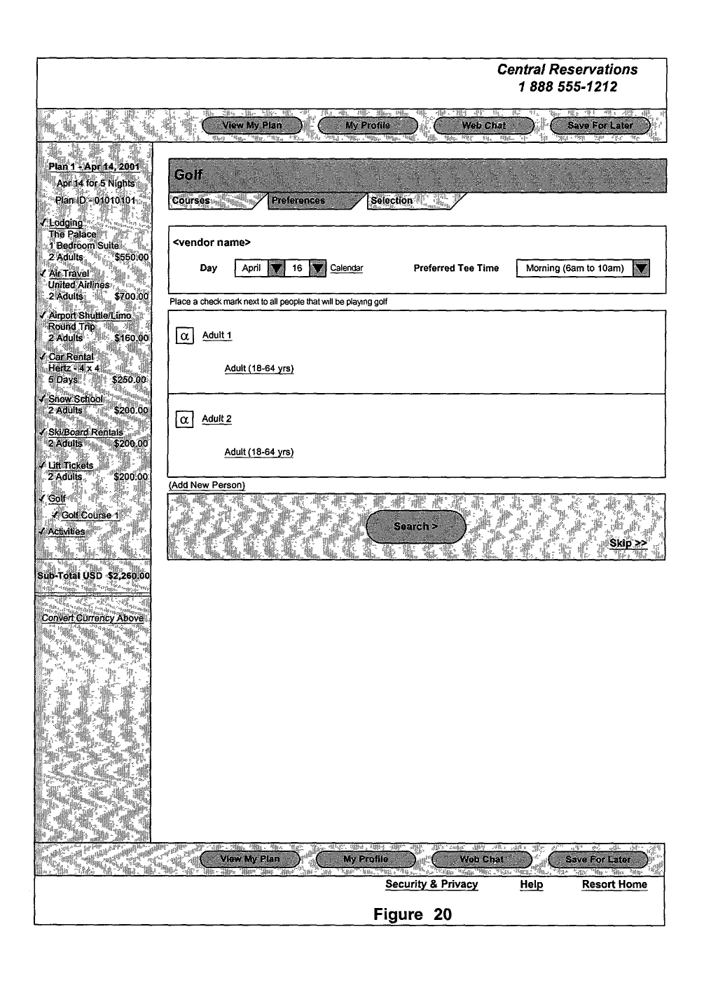

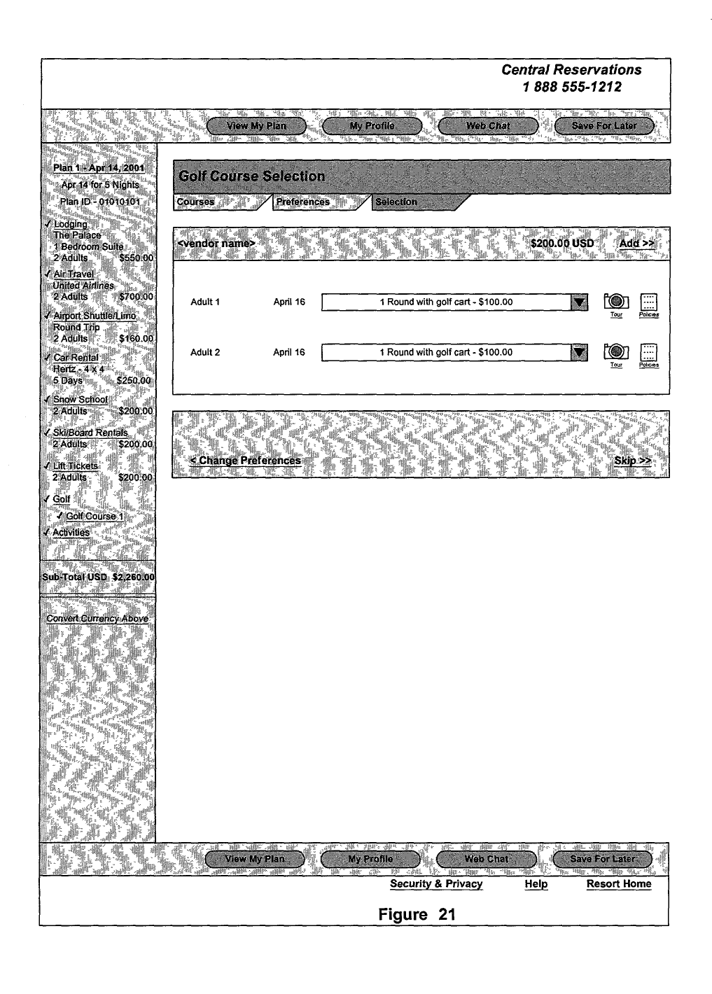

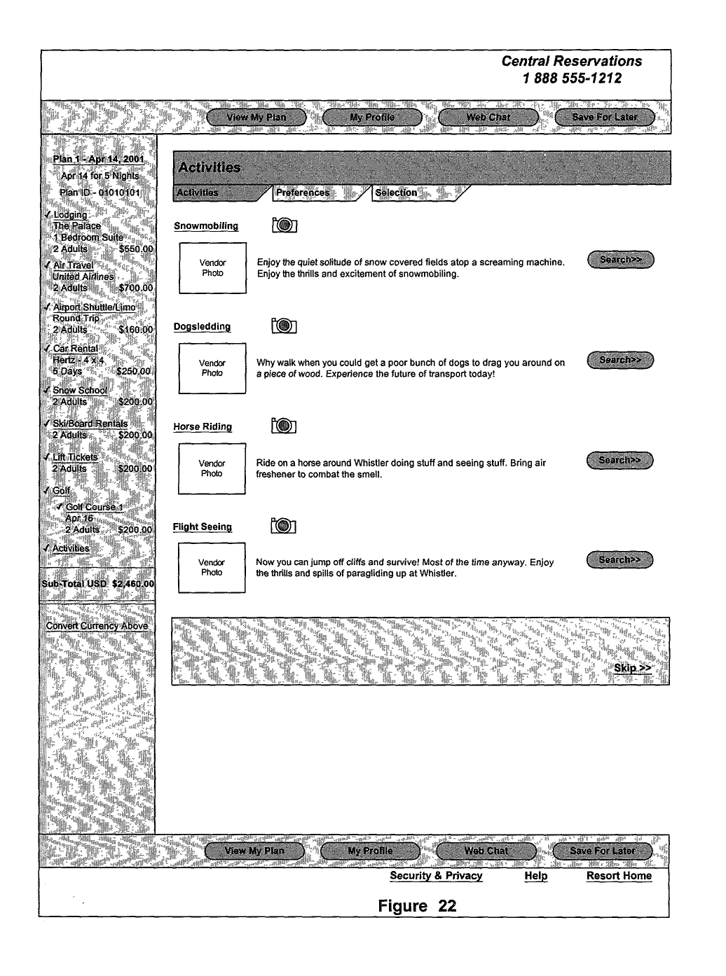

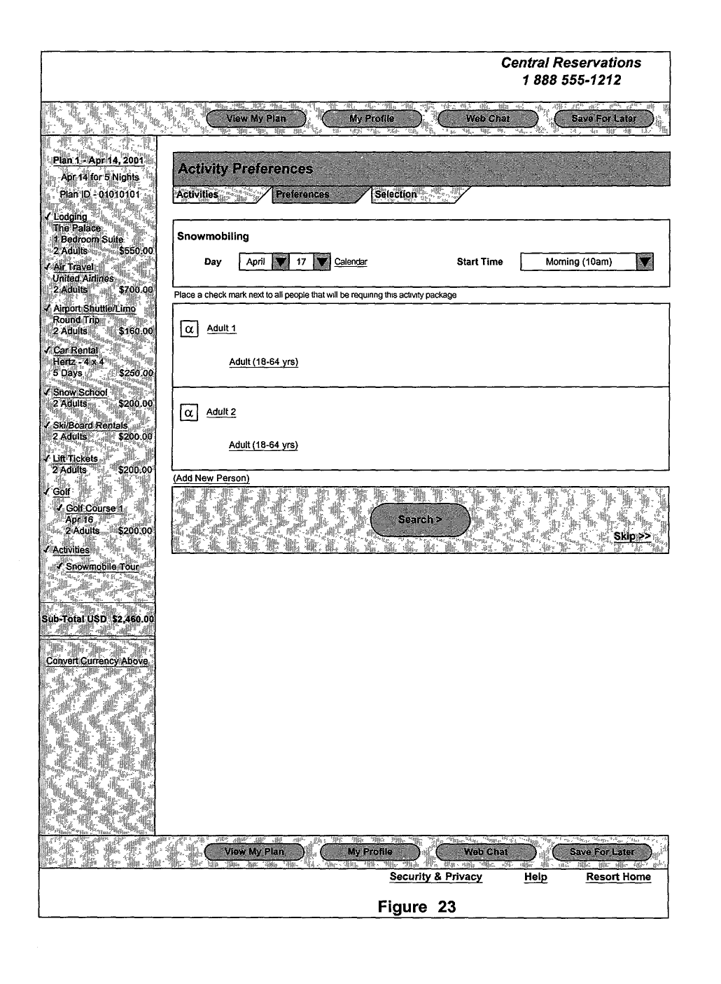

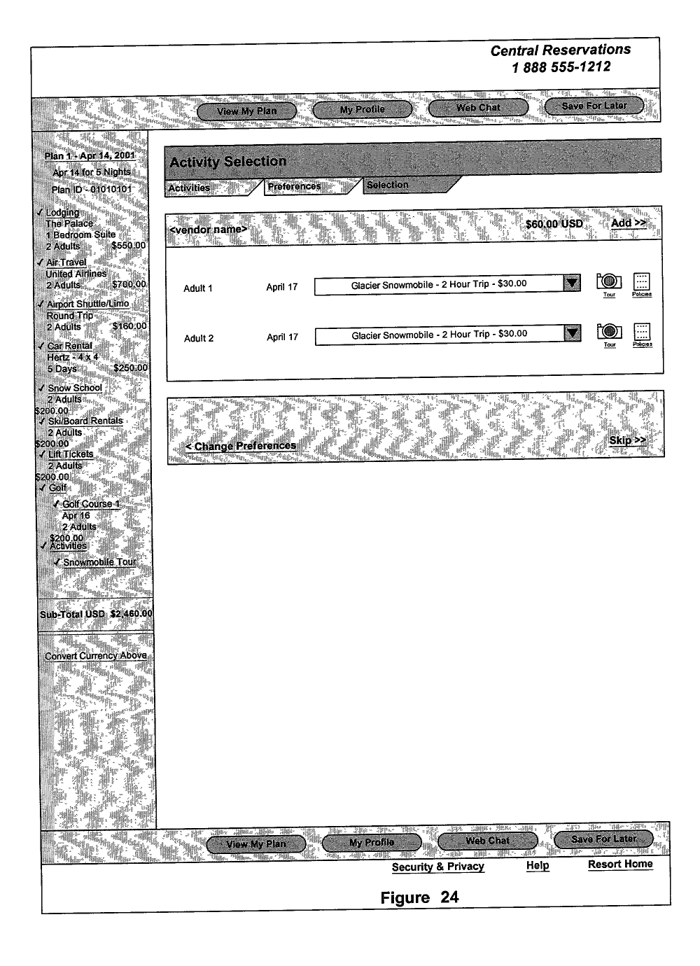

In a preferred embodiment, the selection of “Golf” and “Activities” services use a three-step process. In the first step, based on user 10's chosen values for the resort and the dates, the available values for the particular parameter, i.e., the golf courses at the chosen destination in case of “Golf”, and the types of activities available at the resort, such as snowmobiling, dogsledding, horse riding, sight seeing and the like, in the case of “Activities”, will be displayed on the web page from which user 10 can make choices. In the second step, at the “Preferences” web page, determined by values chosen by user 10 earlier, a web page is displayed in which user 10 enters details (or accepts defaults) about the individuals in user 10's party who will participate in the particular activity, and the preferred date and time for the activity. In the third step, at the “Selections” web page, determined by user 10's previous value choices, the services available are displayed for user 10 to review and/or select from. These three-step selection processes are demonstrated in the following web page combinations: “Golf Courses”, “Golf Preferences” and “Golf Course Selections” web pages (FIGS. 19 to 21); “Activities”, “Activity Preferences” and “Activity Selection” web pages (FIGS. 22 to 24).

In a preferred embodiment, at any web page prior to confirmation, a summary of all the selections made by user 10 appears in the left margin of the web page in the summary bar. A “Plan ID”, also appears in the left margin of every web page, is assigned to the travel plan by user 10. Furthermore, at any web page prior to confirmation, user 10 can view the selections made of service providers, by clicking the “View My Plan” button on the web page. As seen in FIGS. 25 and 26, in addition to the details of all the services selected by user 10, the “My Plan” web page contains buttons for user 10 to delete or change such selections.

If user 10 does not wish to confirm the plan immediately, user 10 can save the prepared vacation plan for later review and confirmation, by clicking the “Save My Plan for Later” button located on the “My Plan” web page. When this option is clicked on, the “Save My Plan” web page, as seen in FIG. 35, is presented and user 10 can save the prepared plan by entering an email address and a password. User 10 is also be prompted to enter a specific piece of personalized information, such as user 10's mother's maiden name, so if user 10 forgets the password in future, user 10 can nevertheless access the saved travel plan. User 10 can save several plans under a single email/password combination, or store several different plans each with its own password..

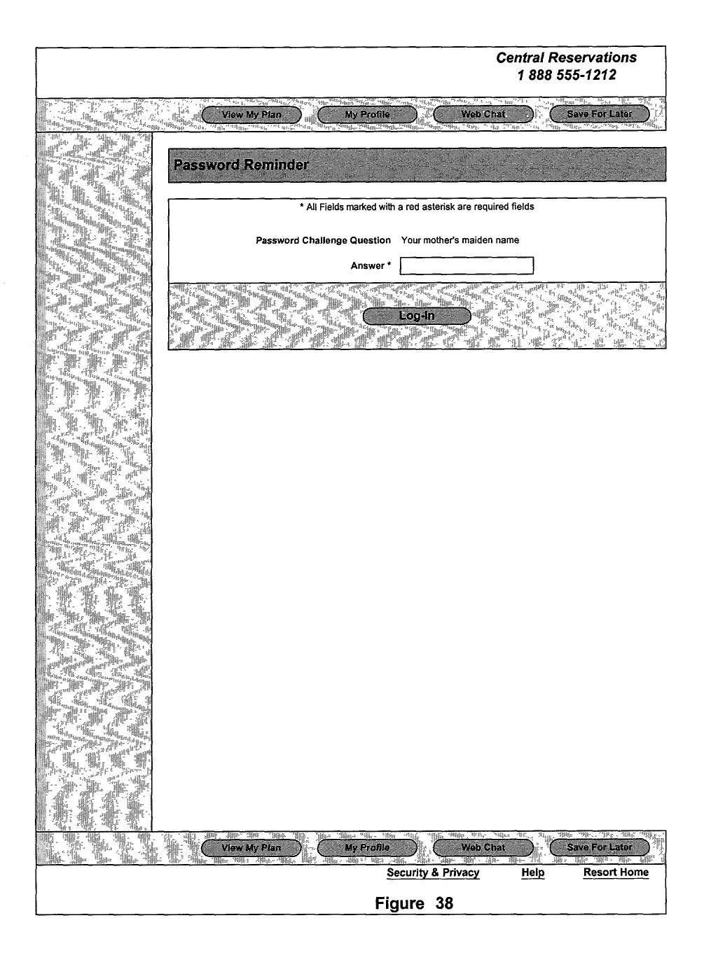

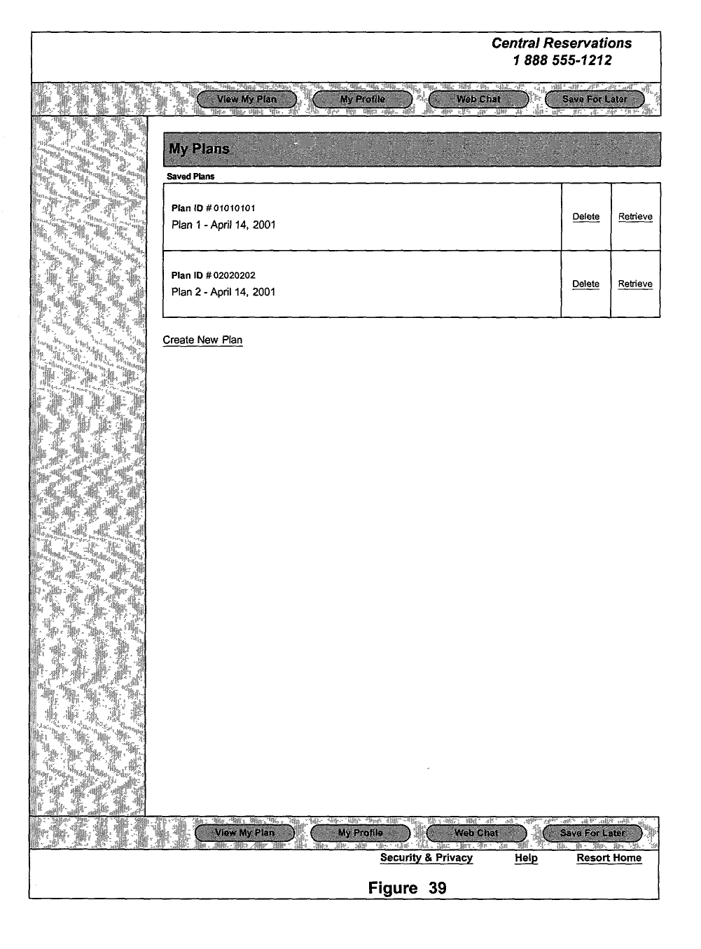

User 10 can access the saved plan or plans by accessing the “Log-in” web page as seen in FIG. 37, and entering the previously chosen email address and password. If user 10 cannot remember the previously-entered password, user 10 can click the “Forgot your password?” button which will display the “Password Reminder” web page, as seen in FIG. 38, prompting user 10 to enter the previously entered personalized information, such as user 10's mother's maiden name. When the correct email and password are entered, all the plans saved under the particular email/password set are displayed on the “My Plans” web page, as seen in FIG. 39, under the “Plan ID” and dates of each travel plan. Each travel plan may be deleted by clicking the “Delete” button next to it, or retrieved by clicking the “Retrieve” button next to it, in which case, the “My Plan” web page, containing the details of the particular plan will appear.

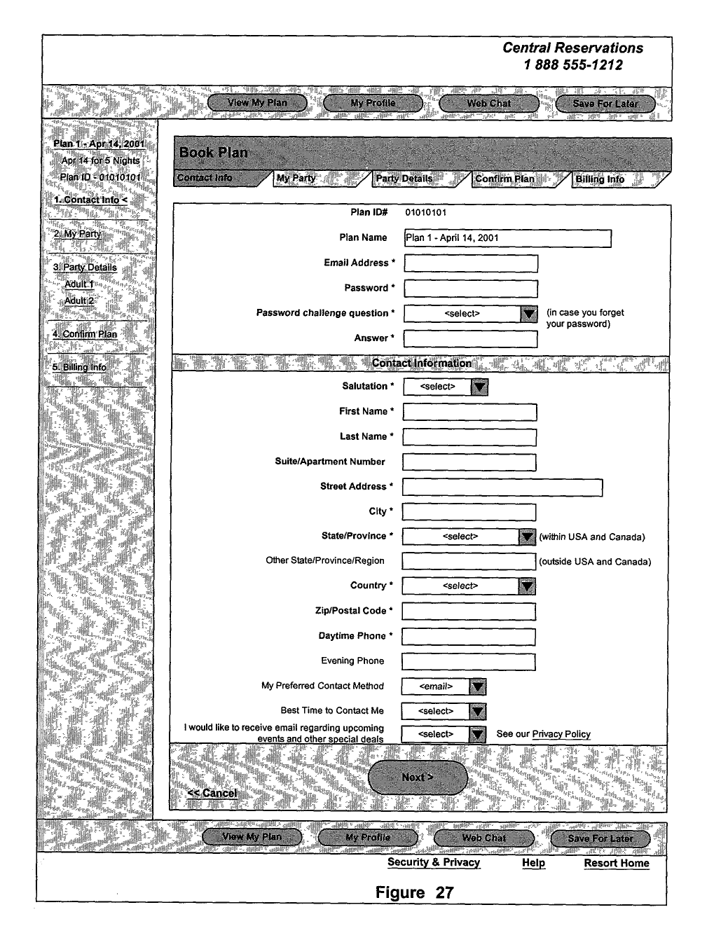

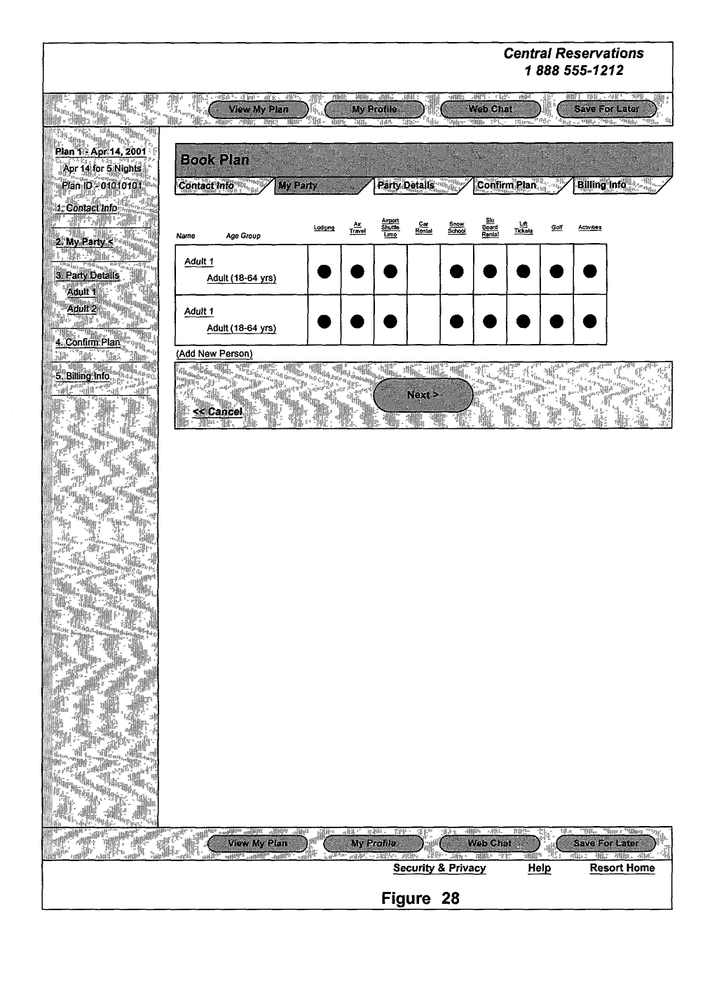

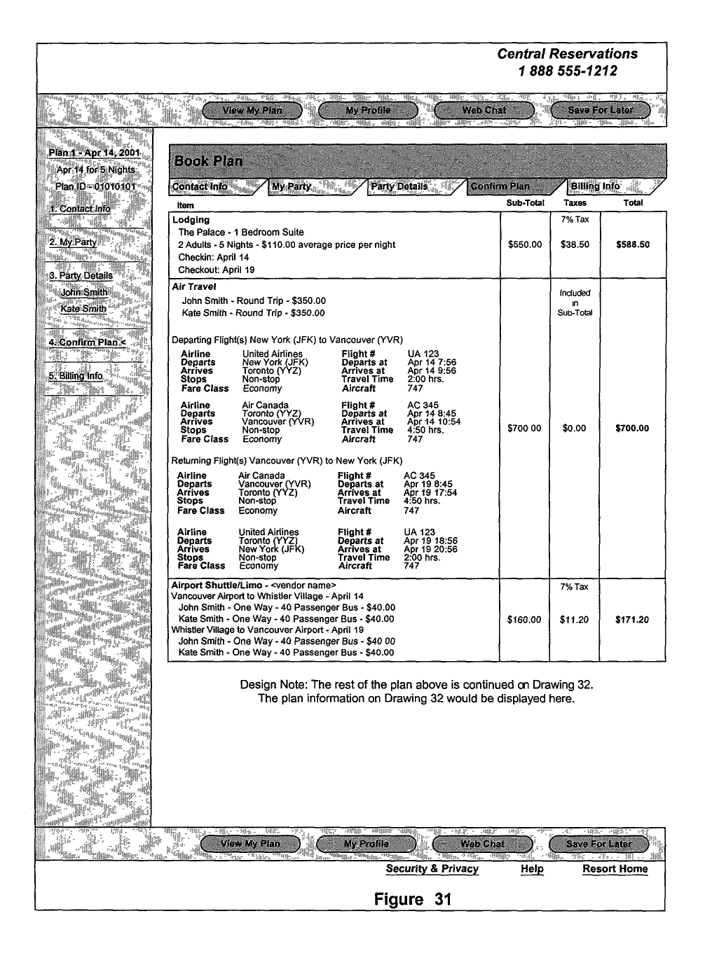

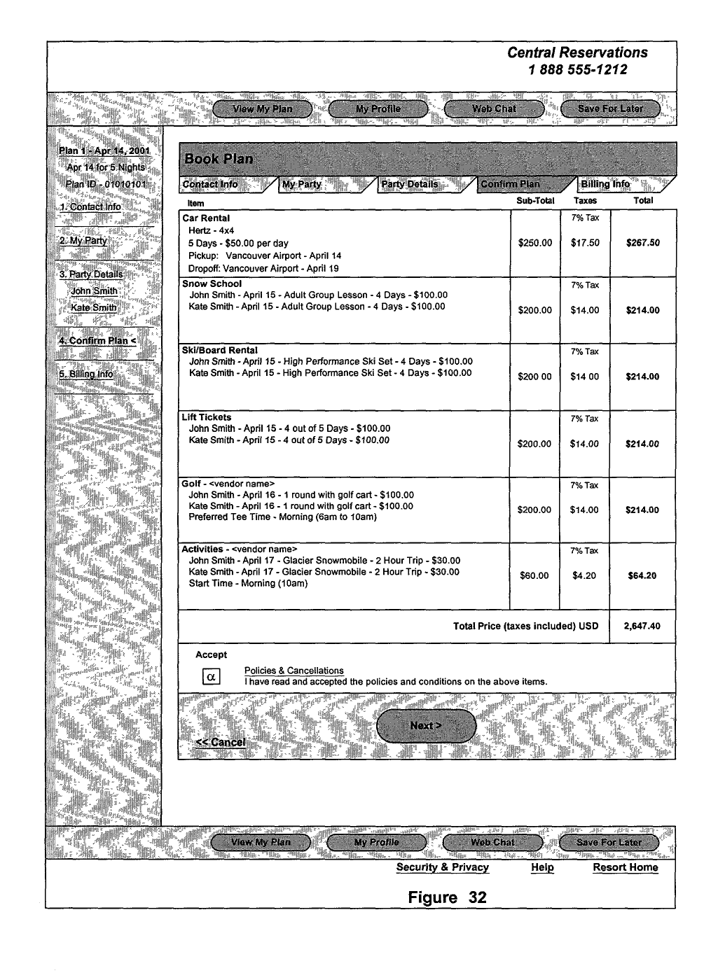

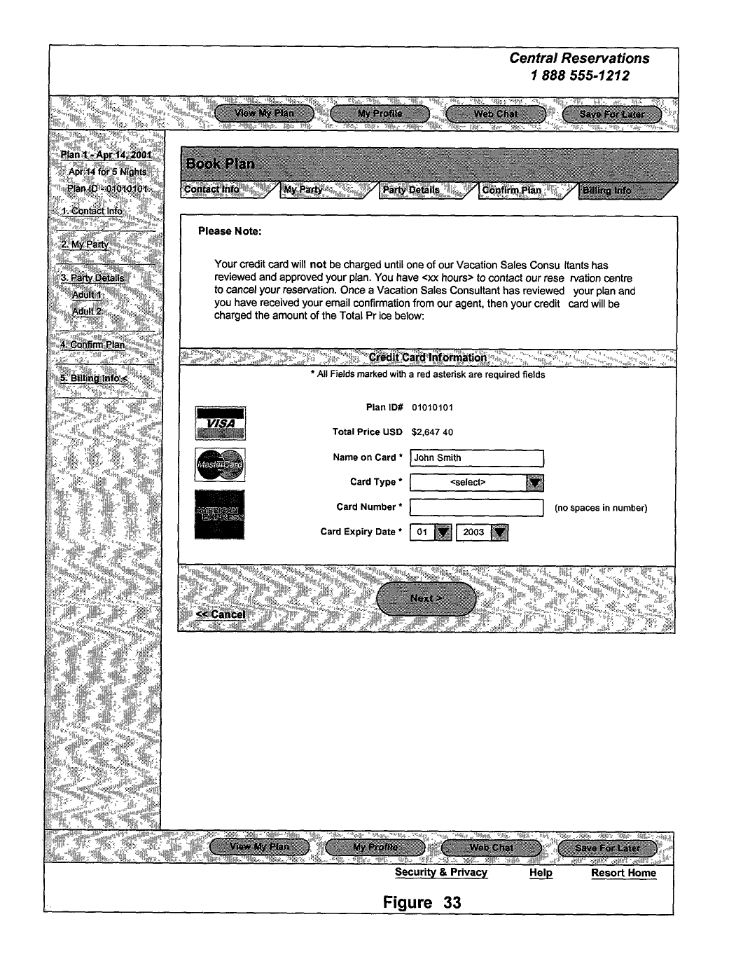

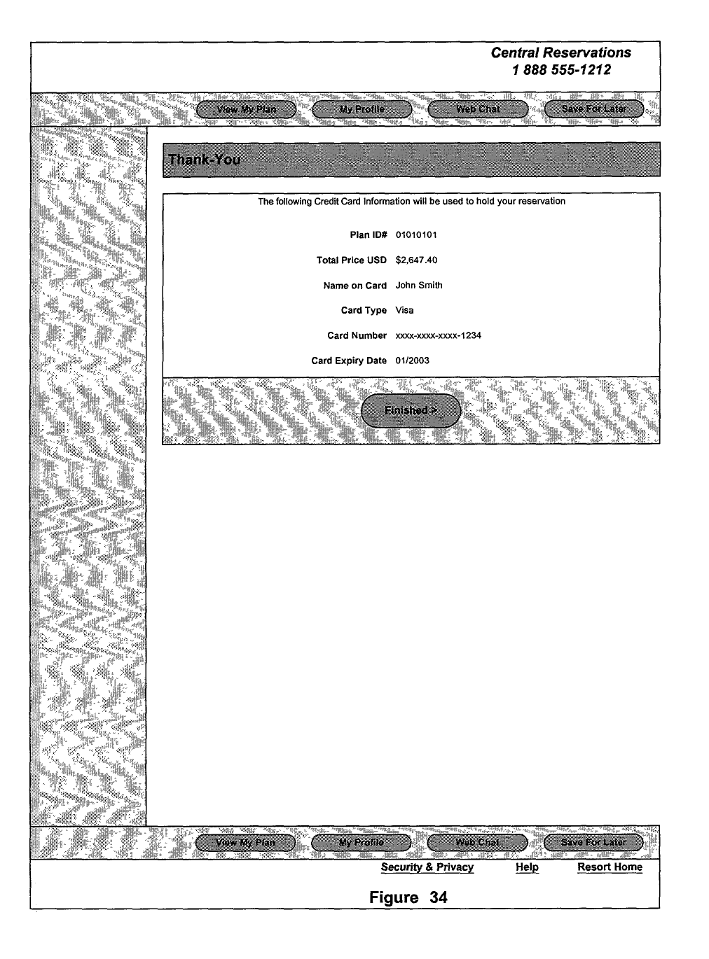

As seen in FIG. 26, user 10 can confirm a developed travel plan from the “My Plan” web page by clicking the “Book My Plan Now” button. On clicking that button, the “Book Plan” web page, as seen in FIG. 27, appears which, in addition to prompting user 10 to enter an email, a password and a piece of personalized information for saving the plan, also prompts user 10 to enter detailed contact information, including personal information. Once user 10 enters the required information, user 10 can proceed in the confirmation process by pressing the “Next” button at the bottom of the web page. Then, as seen in FIG. 28, a chart is displayed that shows each of the members of user 10's party, with the information known by VPS 26 about each member determined from earlier choices. At this stage, user 10 has the option of adding another person to the travel plan, by clicking the “Add New Person” button. User 10 then proceeds by pressing the “Next” button, which prompts user 10 to enter information about the first member of user 10 party, and the individual choices relevant to that member that have not been previously entered, such as boot size and ski type, as may be seen in FIG. 29. Clicking the “Next” button will take user 10 through consecutive web pages prompting user 10 to enter similar relevant information about each member of user 10's party, as seen in FIG. 30. On clicking “Next” after completion of entering information about the last member of user 10's party, the entire travel plan developed by user 10, including all of the services selected by user 10, will be displayed on the web page, as seen in FIGS. 31 and 32. At this stage, user 10 can review the policies, including the cancellation policy, for the various services of the travel plan by clicking the “Policies & Cancellations” button. Prior to proceeding further, user 10 has to accept the policies by clicking the box beside the “Policies & Cancellations” button. If user 10 wishes to confirm the plan, user 10 can click the “Next” button. On clicking the “Next” button, as seen in FIG. 33, user 10 is prompted to enter credit card information. On entering the required credit card information and clicking “Next”, the credit information provided by user 10 will be redisplayed on the “Thank-You” web page at which point user 10 can complete the confirmation process by pressing the “Finished” button at the bottom of the web page, as seen in FIG. 34.

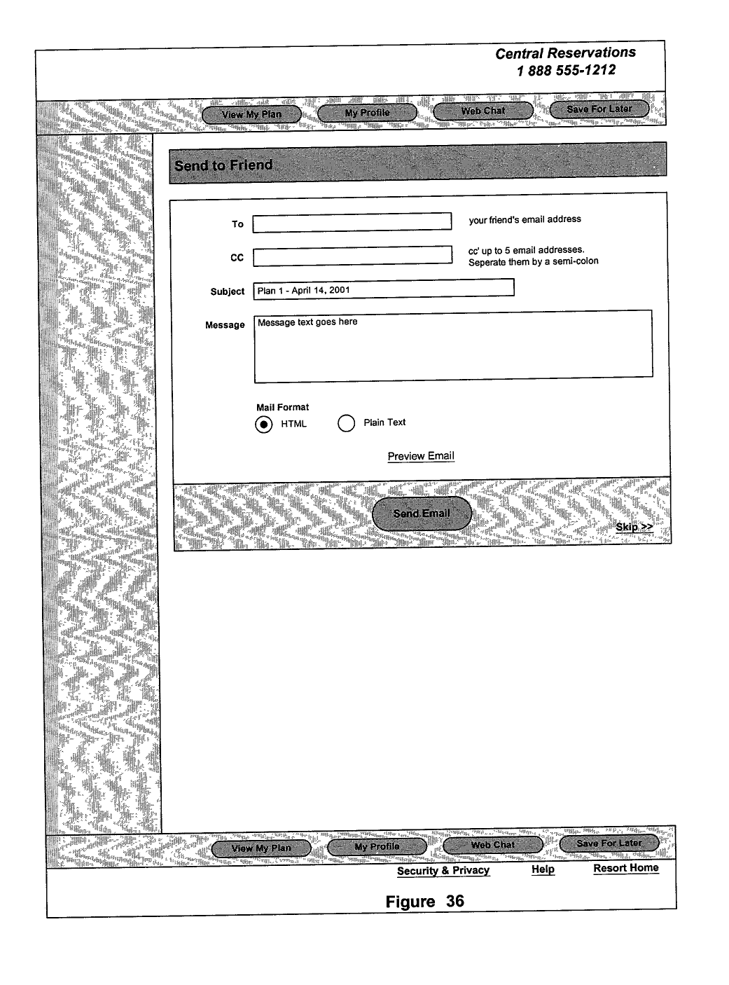

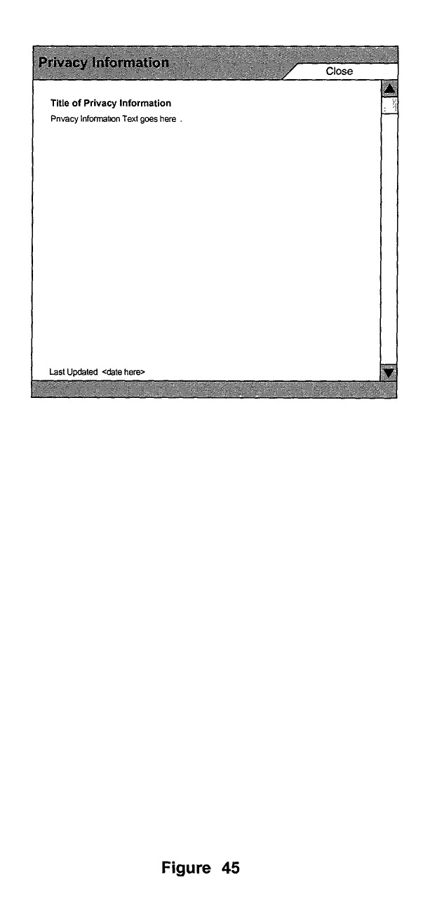

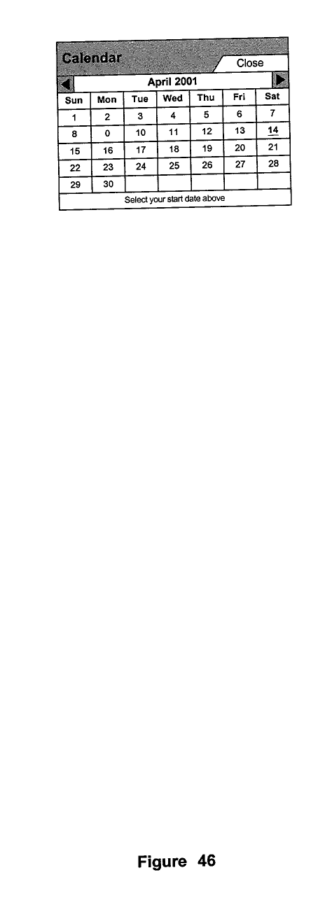

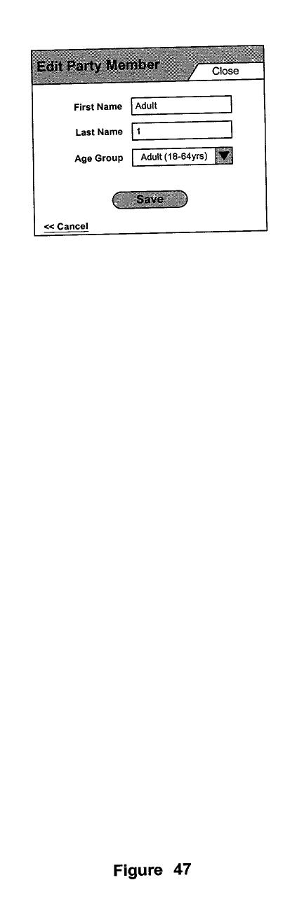

As seen in FIGS. 27 to 33, on every “Book Plan” web page, the summary bar in the left margin of each web page displays the at which stage of the confirmation process user 10 is at and allows user 10 to return to previously visited web pages to amend the plan before confirmation. A further feature of VPS 26 is that it allows user 10 to send a text version of the developed travel plan, by choosing to “Send to Friend”, which prompts a pop up window as seen in FIG. 36. Other features of VPS 26 accessible to user 10 include access to pop up windows containing privacy policies relating to VPS 26 (FIG. 45); an interactive calendar for viewing and choosing dates (FIG. 46); and the option to edit a party member from any point within VPS 26 (FIG. 47).

While the principles of the invention have now been made clear in the illustrated embodiments, it will be immediately obvious to those skilled in the art that many modifications may be made of structure, arrangements, and algorithms used in the practice of the invention, and otherwise, which are particularly adapted for specific environments and operational requirements, without departing from those principles. The claims are therefore intended to cover and embrace such modifications within the limits only of the true spirit and scope of the invention.

What is claimed is:

1. A method for a user to develop a travel plan having at least two travel components, comprising the steps of:
(a) providing a plurality of parameters on which each said travel component is parameterized by at least one of said plurality of parameters, wherein each said parameter is associated with an initial range of values;
(b) providing first means for choosing by user, a value for a first parameter;
(c) determining the respective ranges of values of all parameters other than said first parameter, responsively to said chosen first parameter value according to predefined relationships between said other parameters and said first parameter; and
(d) presenting to the user said determined range of values for said other parameters.

2. The method of claim 1, further comprising:
(e) providing second means for choosing by user, a value for a second parameter from its range of values determined as aforementioned;
(f) determining the respective ranges of values of all other parameters, responsively to said chosen second parameter value, according to predefined relationships between said second parameter and all other parameters, wherein said first and second choosing means are on different physical or computer sites.

3. The method of claim 2, wherein said step of determining the respective ranges determines the respective ranges of parameters including those for which a value has already been chosen.

4. The method of claim 3, wherein said travel plan has three travel components.

5. The method of claim 4, wherein said first parameter is a destination.

6. The method of claim 5, wherein said second parameter is an arrival date at said destination and a departure date from said destination.

7. The method of claim 6, wherein the range of selections determined for goods or services satisfying said chosen values of first and second parameters, is presented to the user in association with a multimedia presentation.

8. The method of claim 7, wherein said first choosing means is operated by a travel service provider.

9. The method of claims 1-8, further comprising:
(g) providing means for amending a chosen value of a parameter, wherein amendment thereof automatically amends the values of all previously chosen values for parameters according to predefined relationships all other parameters and said parameter whose value was amended.

10. A method for a user to develop a travel plan having at least three travel components comprising the steps of:
(a) providing a plurality of parameters on which each said travel component is parameterized by at least one of said plurality of parameters, wherein each said parameter is associated with an initial range of values;
(b) providing means for choosing by user, a value for a destination;
(c) determining the respective ranges of values of all parameters other than said first parameter, responsively to said chosen destination according to predefined relationships between said other parameters and said destination; and
(d) presenting to the user said determined range of values for said other parameters.

11. The method of claim 10, further comprising:
(e) providing means for choosing by user, a value for an arrival date and a departure date;
(f) determining the respective ranges of values of all parameters, responsively to said arrival date and departure date and said destination.

12. The method of claim 11, further comprising:
(g) providing means for choosing by user, the value of a parameter for activities at said destination;
(h) determining the respective ranges of values of all parameters, responsively to said destination, said arrival date and departure date and said chosen values for activities.

13. The method of claim 12, wherein values for other parameters associated in predefined relationships with said chosen parameter, defaults to a value determined by said previously chosen values.

14. The method of claim 12, further comprising:
(i) providing means for choosing by user, the value for a parameter for lodging, said parameters for lodging comprising at least two of: price range; type of lodging; location within said destination; and type of room;
(j) determining the respective ranges of values of all other parameters for lodging, responsively to said chosen values for parameters, according to predefined relationships.

15. The method of claim 12, further comprising:
(i) providing means for developing a user profile;
(j) determining the respective ranges of values of all other parameters, responsively to said chosen user profile parameter.

16. The method of claim 1, further comprising:
(c) providing means for the user to save said travel plan for subsequent access.

17. The method of claim 1, wherein said first parameter is a budget for the plan.

18. A method for a user having personal information, to develop a travel plan, comprising the steps of:
(a) providing means for developing a user profile;
(b) providing means for developing by user, the travel plan wholly or partially, in conjunction with said user profile;
(c) providing means for confirming by user said developed travel plan, wherein content of said user profile is under the control of the user throughout the development of the travel plan, and includes personal information or not as controlled by the user, and wherein the user is required to include personal information in said user profile only to confirm said developed travel plan.

19. The method of claim 18, further comprising the step of providing means for saving said developed travel plan and for subsequent retrieving by user for further development or confirmation.

20. The method of claim 19, further comprising the step of providing the user means for creating an identity for association with said travel plan for purposes of saving and retrieving said travel plan.

21. The method of claim 20, wherein said identity is not related to said user's true identity.

22. The method of claim 19, further comprising providing means for amending, by user, said user profile to include or remove personal information from said user profile at any time before confirming the plan.

23. A method for assisting a user to obtain goods or services via a computer user interface, comprising the steps of:
(a) displaying in a first window on said user interface, a plurality of goods or services for selection;
(b) providing a multimedia presentation associated with a first goods or services;
(c) providing means for presenting said multimedia presentation to the user in a second window; and
(d) providing means for selecting goods or services to obtain via said second window on said user interface.

24. The method of claim 23, further comprising:
(e) providing means for presenting, in said second window, a second multimedia presentation associated with a second goods or services.

25. The method of claim 24, wherein said goods or services are related to lodgings.

26. The method of claim 25, wherein said multimedia presentation is an interior view of a lodging.

27. The method of claim 25, wherein said goods or services are related to recreational activities.

28. A method for a user to select a round trip air travel package, comprising:
(a) the user providing a departure location, a destination, a departure date, and a return date;
(b) determining at least a departing flight and a returning flight consistent with said departure and return dates, said destination and said departure location;
(c) grouping said departing flights and said returning flights according to the price of pairs of said departure flights and arrival flights;
(d) displaying said groups of departure flights and return flights to the user;
(e) providing means for selecting by user, a departing flight and a returning flight from one of said groups.

29. A system for providing interaction between a vacation sales consultant and a user comprising:
(a) a first computer connected to a network and operable by the vacation sales consultant;
(b) a second computer connected to a network and operable by the user;
(c) means for developing a travel plan by the vacation sales consultant on said first computer for subsequent transfer to and display on said second computer;
(d) means for the user to change directly said travel plan on said second computer,

30. The system of claim 29, wherein said means for developing travel plan is implemented by the method of claim 1.

31. The system of claim 30 wherein said travel plan is a web page at a website and accessible and displayable on said second computer.

32. The system of claim 31, further comprising means for securing access to said travel plan with a key, and wherein said travel plan is accessible and displayable at the web site by the user only via user use of said key.

33. The system of claim 32 wherein said travel plan is saved for future use.

34. The system of claim 33 wherein the user may access said saved travel plan.

35. The system of claim 34 wherein said changed travel plan is accessible by the vacation sales consultant.

36. A method for an aggregator to sell its package of component goods or services, to a customer, comprising the steps of:
(a) an aggregator supplying a provider of component goods or services, with means for selling the package, wherein the package includes said provider's component goods or services;
(b) the customer purchasing the package via said selling means;
(c) said provider sharing with said aggregator the revenue received in association with said purchase of package.

37. The method of claim 36 wherein said selling means includes customer planning means for organizing said package's component goods or services into categories, for associating said provider's component goods or services with a particular category, and for making available for purchase only said provider's component goods or services for said category.

38. The method of claim 37 wherein said provider retains that portion of said revenue associated with said provider's component goods or services, and said aggregator retains the remainder of said revenue.

39. The method of claim 38 wherein said selling means is customized to suit said provider.

40. The method of claim 39 wherein said package is a travel plan and said provider is one that provides a travel component which is the only component in its category made available for purchase.

41. The method of claim 40, wherein said package is a computer system and said provider is one that provides one of the hardware or software components of the computer system, which is the only component in its category made available for purchase.

42. A computer system for a user using a web site for the development of plan to obtain goods or services, comprising:
(a) means for organizing the goods or services into categories;
(b) means for determining the goods or services that are available for user to choose;
(c) user means for choosing goods or services from said available goods or services;
(d) user interface means, for providing in a summary bar: (i) means for displaying information about each category of goods or services, each said category information being also a link to additional information about each said category and to said choosing means; and (ii) means for displaying summary information of chosen goods or services.

43. The system of claim 42, further comprises:
(f) means for parameterizing each goods or services; and
(g) user means for selecting values for said parameters;
and wherein said availability determining means operates on the values selected previously for one or more of said parameters.

44. The system of claim 43, wherein said summary information of chosen goods or services includes the associated price(s).

45. The system of claim 44, further comprising budgeting means for accumulating the price of each said chosen goods or services into a running total price and including said running total price in said summary information.

46. The system of claim 45, further comprising means for user changing a selected value, wherein all consequential amendments are automatically effected and said navigation bar means displays updated selections and total price.

47. The system of claim 46, wherein goods or services which are not available are still displayed but said link is not active for said unavailable goods or services.

48. The system of claim 47, wherein said service is a travel plan.

49. The system of claim 48, wherein said goods is a computer system.
